(19) United States
(12) Patent Application Publication
(10) Pub. No.: US 2019/0297332 A1
(43) Pub. Date: Sep. 26, 2019

(54) SYSTEM AND METHOD FOR SUPPORTING VIDEO BIT STREAM SWITCHING

(71) Applicant: SZ DJI TECHNOLOGY CO., LTD., Shenzhen (CN)

(72) Inventors: Xiaozhen ZHENG, Shenzhen (CN); Wenjun ZHAO, Shenzhen (CN)

(21) Appl. No.: 16/439,116

(22) Filed: Jun. 12, 2019

Related U.S. Application Data
(63) Continuation of application No. PCT/CN2016/109971, filed on Dec. 14, 2016.

(51) Int. Cl. H04N 19/159; H04N 19/597; H04N 19/176; H04N 19/172; H04N 19/36; H04N 19/124

(52) U.S. Cl. CPC H04N 19/159; H04N 19/597; H04N 19/124; H04N 19/172; H04N 19/36; H04N 19/176

(57) ABSTRACT

A method for video decoding includes obtaining a bit stream for a sequence of image frames, each of which is partitioned into a plurality of sections according to a partition scheme, obtaining an indicator indicating that decoding prediction dependency for a particular section of each image frame in the sequence of image frames is constrained within said particular section, performing decoding prediction for said particular section of a first image frame in the sequence of image frames based on said particular section of a second image frame in the sequence of image frames, and decoding said particular section of the first image frame based on the decoding prediction.

### CROSS-REFERENCE TO RELATED APPLICATION

This application is a continuation of International Application No. PCT/CN2016/109971, filed on Dec. 14, 2016, the entire content of which is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

The disclosed embodiments relate generally to video processing, more particularly, but not exclusively, to video streaming, encoding and decoding.

### BACKGROUND

The consumption of video content has been surging in recent years, mainly due to the prevalence of various types of portable, handheld, or wearable devices. For example, the virtual reality (VR) or augmented reality (AR) capability can be integrated into different head mount devices (HMDs). As the form of video content become more sophisticated, the storage and transmission of the video content become ever more challenging. For example, there is a need to reduce the bandwidth for video storage and transmission. This is the general area that embodiments of the disclosure are intended to address.

### SUMMARY

Described herein are systems and methods that can stream a video, such as a panoramic or wide view video. A streaming controller or a decoder can partition a first image frame in a sequence of image frames into a plurality of sections based on a partition scheme, and determine encoding quality for each section in the first image frame. Furthermore, the streaming controller or a decoder can obtain, for each section of the first image frame, encoded data with the determined encoding quality, and incorporate the encoded data for the plurality of sections of the first image frame in a bit stream according to a predetermined order.

Also described herein are systems and methods that can encode a video, such as a panoramic or wide view video. A encoder can partition each image frame in a sequence of image frames into a plurality of sections according to a partition scheme; perform encoding prediction for a particular section of a first image frame in the sequence of image frames based on said particular section of a second image frame in the sequence of image frames; encode said particular section of the first image frame based on the encoding prediction; incorporate encoded data for said particular section of the first image frame in a bit stream for the sequence of image frames; and associate an indicator with the bit stream, wherein the indicator indicates that encoding prediction dependency for said particular section of each image frame in the sequence of image frames is constrained within said particular section.

Also described herein are systems and methods that can decode a video, such as a panoramic or wide view video. A decoder can obtain a bit stream for a sequence of image frames, wherein each said image frame is partitioned into a plurality of sections according to a partition scheme; obtain an indicator indicating that decoding prediction dependency for a particular section of each image frame in the sequence of image frames is constrained within said particular section; perform decoding prediction for said particular section of a first image frame in the sequence of image frames based on said particular section of a second image frame in the sequence of image frames; and decode said particular section of the first image frame based on the decoding prediction.

### BRIEF DESCRIPTION OF DRAWINGS

FIG. 1 illustrates coding/compressing a curved view video, in accordance with various embodiments of the present disclosure.

FIG. 2 illustrates an exemplary equirectangular projection that can map a three dimensional spherical view to a two-dimensional plane, in accordance with various embodiments of the present disclosure.

FIG. 3 illustrates an exemplary cubic face projection that maps a three dimensional spherical view to a two-dimensional layout, in accordance with various embodiments of the present disclosure.

FIG. 4 illustrates mapping a curved view into a two-dimensional (2D) image, in accordance with various embodiments of the present disclosure.

FIG. 5 illustrates an exemplary video streaming environment, in accordance with various embodiments of the present disclosure.

FIG. 6 illustrates exemplary image partition schemes based on tiles, in accordance with various embodiments of the present disclosure.

FIG. 7 illustrates encoding an image frame sequence for supporting video streaming, in accordance with various embodiments of the present disclosure.

FIG. 8 illustrates supporting bit stream switching in video streaming using tiles, in accordance with various embodiments of the present disclosure.

FIG. 9 illustrates bit stream switching in video streaming using tiles, in accordance with various embodiments of the present disclosure.

FIG. 10 illustrates exemplary image partition schemes based on slice, in accordance with various embodiments of the present disclosure.

FIG. 11 illustrates encoding an image frame sequence for supporting video streaming, in accordance with various embodiments of the present disclosure.

FIG. 12 illustrates supporting bit stream switching in video streaming using slices, in accordance with various embodiments of the present disclosure.

FIG. 13 illustrates bit stream switching in video streaming using slices, in accordance with various embodiments of the present disclosure.

FIG. 14 illustrates supporting scaling for bit stream switching in video streaming, in accordance with various embodiments of the present disclosure.

FIG. 15 illustrates a flow chart for supporting bit stream switching in video streaming, in accordance with various embodiments of the present disclosure.

FIG. 16 illustrates encoding tiles for supporting bit stream switching in video streaming, in accordance with various embodiments of the present disclosure.

FIG. 17 illustrates tile-based encoding without inter-frame prediction dependency constraint, in accordance with various embodiments of the present disclosure.

FIG. 18 illustrates tile-based encoding with inter-frame prediction dependency constraint, in accordance with various embodiments of the present disclosure.

FIG. 19 illustrates encoding slices for supporting bit stream switching in video streaming, in accordance with various embodiments of the present disclosure.

FIG. 20 illustrates slice-based encoding without inter-prediction dependency constraint, in accordance with various embodiments of the present disclosure.

FIG. 21 illustrates slice-based encoding with inter-prediction dependency constraint, in accordance with various embodiments of the present disclosure.

FIG. 22 illustrates a flow chart for video encoding for bit stream switching in video streaming, in accordance with various embodiments of the present disclosure.

FIG. 23 illustrates decoding tiles for supporting bit stream switching in video streaming, in accordance with various embodiments of the present disclosure.

FIG. 24 illustrates tile-based decoding with inter-frame prediction dependency constraint, in accordance with various embodiments of the present disclosure.

FIG. 25 illustrates decoding slices for supporting bit stream switching in video streaming, in accordance with various embodiments of the present disclosure.

FIG. 26 illustrates slice-based decoding with inter-prediction dependency constraint, in accordance with various embodiments of the present disclosure.

FIG. 27 illustrates a flow chart for video decoding for bit stream switching in video streaming, in accordance with various embodiments of the present disclosure.

FIG. 28 illustrates a movable platform environment, in accordance with various embodiments of the present disclosure.

### DETAILED DESCRIPTION

The disclosure is illustrated, by way of example and not by way of limitation, in the figures of the accompanying drawings in which like references indicate similar elements. It should be noted that references to “an” or “one” or “some” embodiment(s) in this disclosure are not necessarily to the same embodiment, and such references mean at least one.

In accordance with various embodiments of the present disclosure, systems and methods can stream a video, such as a panoramic or wide view video. A streaming controller or a decoder can partition a first image frame in a sequence of image frames into a plurality of sections based on a partition scheme, and determine encoding quality for each section in the first image frame. Furthermore, the streaming controller or a decoder can obtain, for each section of the first image frame, encoded data with the determined encoding quality, and incorporate the encoded data for the plurality of sections of the first image frame in a bit stream according to a predetermined order.

In accordance with various embodiments of the present disclosure, systems and methods can encode a video, such as a panoramic or wide view video. A encoder can partition each image frame in a sequence of image frames into a plurality of sections according to a partition scheme; perform encoding prediction for a particular section of a first image frame in the sequence of image frames based on said particular section of a second image frame in the sequence of image frames; encode said particular section of the first image frame based on the encoding prediction; incorporate encoded data for said particular section of the first image frame in a bit stream for the sequence of image frames; and associate an indicator with the bit stream, wherein the indicator indicates that encoding prediction dependency for said particular section of each image frame in the sequence of image frames is constrained within said particular section.

In accordance with various embodiments of the present disclosure, systems and methods can decode a video, such as a panoramic or wide view video. A decoder can obtain a bit stream for a sequence of image frames, wherein each said image frame is partitioned into a plurality of sections according to a partition scheme; obtain an indicator indicating that decoding prediction dependency for a particular section of each image frame in the sequence of image frames is constrained within said particular section; perform decoding prediction for said particular section of a first image frame in the sequence of image frames based on said particular section of a second image frame in the sequence of image frames; and decode said particular section of the first image frame based on the decoding prediction.

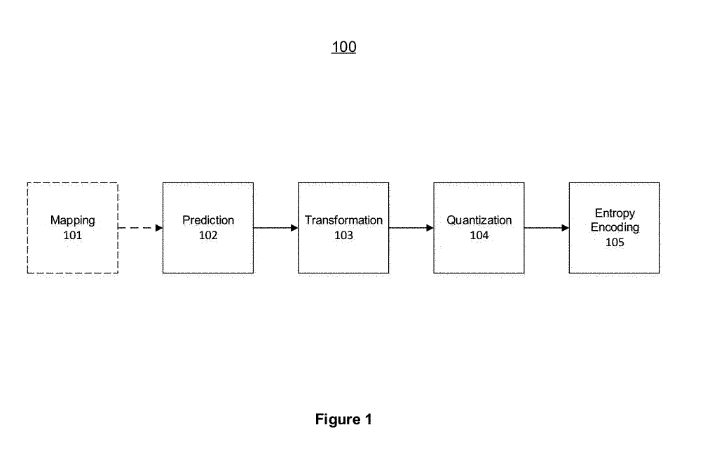

FIG. 1 illustrates coding/compressing a video, in accordance with various embodiments of the present disclosure. As shown in FIG. 1, the coding/compressing of a panoramic or wide view video, such as a curved view video, can involve multiple steps, such as mapping 101, prediction 102, transformation 103, quantization 104, and entropy encoding 105.

In accordance with various embodiments, at the mapping step 101, the system can project a three dimensional (3D) curved view in a video sequence on a two-dimensional (2D) plane in order to take advantage of various video coding/compressing techniques. The system can use a two-dimensional rectangular image format for storing and transmitting the curved view video (e.g. a spherical view video). Also, the system can use a two-dimensional rectangular image format for supporting the digital image processing and performing codec operations.

Different approaches can be employed for mapping a curved view, such as a spherical view, to a rectangular image. For example, a spherical view can be mapped to a rectangular image based on an equirectangular projection. In some embodiments, an equirectangular projection can map meridians to vertical straight lines of constant spacing and can map circles of latitude to horizontal straight lines of constant spacing. Alternatively, a spherical view can be mapped into a rectangular image based on cubic face projection. A cubic face projection can approximate a 3D sphere surface based on its circumscribed cube. The projections of the 3D sphere surface on the six faces of the cube can be arranged as a 2D image using different cubic face layouts, which defines cubic face arrangements such as the relative position and orientation of each individual projection. Apart from the equirectangular projection and the cubic face projection as mentioned above, other projection mechanisms can be exploited for mapping a 3D curved view into a 2D video. A 2D video can be compressed, encoded, and decoded based on some commonly used video codec standards, such as HEVC/H.265, H.264/AVC, AVS1-P2, AVS2-P2, VP8, VP9.

In accordance with various embodiments, the prediction step 102 can be employed for reducing redundant information in the image. The prediction step 102 can include intra-frame prediction and inter-frame prediction. The intra-frame prediction can be performed based solely on information that is contained within the current frame, independent of other frames in the video sequence. Inter-frame prediction can be performed by eliminating redundancy in the current frame based on a reference frame, e.g. a previously processed frame.

For example, in order to perform motion estimation for inter-frame prediction, a frame can be divided into a plurality of image blocks. Each image block can be matched to a block in the reference frame, e.g. based on a block matching algorithm. In some embodiments, a motion vector, which represents an offset from the coordinates of an image block in the current frame to the coordinates of the matched image block in the reference frame, can be computed. Also, the residuals, i.e. the difference between each image block in the current frame and the matched block in the reference frame, can be computed and grouped.

Furthermore, the redundancy of the frame can be eliminated by applying the transformation step 103. In the transformation step 103, the system can process the residuals for improving coding efficiency. For example, transformation coefficients can be generate by applying a transformation matrix and its transposed matrix on the grouped residuals. Subsequently, the transformation coefficients can be quantized in a quantization step 104 and coded in an entropy encoding step 105. Then, the bit stream including information generated from the entropy encoding step 105, as well as other encoding information (e.g., intra-frame prediction mode, motion vector) can be stored and transmitted to a decoder.

At the receiving end, the decoder can perform a reverse process (such as entropy decoding, dequantization and inverse transformation) on the received bit stream to obtain the residuals. Thus, the image frame can be decoded based on the residuals and other received decoding information. Then, the decoded image can be used for displaying the curved view video.

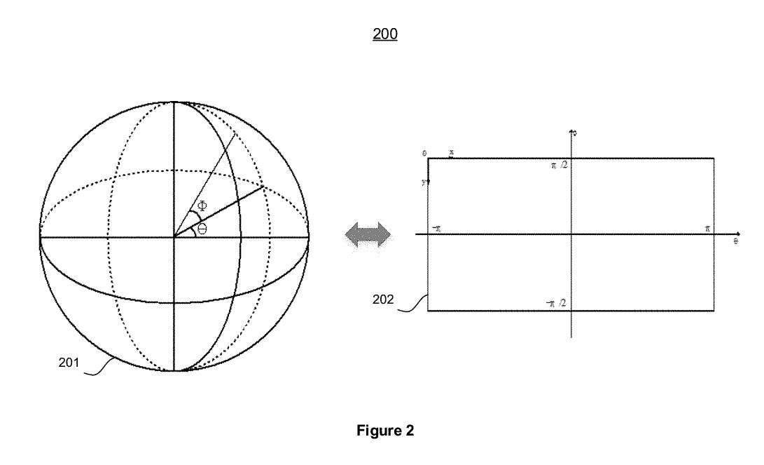

FIG. 2 illustrates an exemplary equirectangular projection 200 that can map a three dimensional spherical view to a two-dimensional plane, in accordance with various embodiments of the present disclosure. As shown in FIG. 2, using an equirectangular projection, the sphere view 201 can be mapped to a two-dimensional rectangular image 202. On the other hand, the two-dimensional rectangular image 202 can be mapped back to the sphere view 201 in a reverse fashion.

In some embodiments, the mapping can be defined based on the following equations.

x=λ cos φ₁ (Equation 1)

y=φ (Equation 2)

Wherein x denotes the horizontal coordinate in the 2D plane coordinate system, and y denotes the vertical coordinate in the 2D plane coordinate system 202. λ denotes the longitude of the sphere 201 from the central merdian, while φ denotes the latitude of the sphere from the the standard parallels. cφ₁ denotes the standard parallels where the scale of the projection is true. In some embodiments, φ₁ can be set as 0, and the point (0, 0) of the coordinate system 202 can be located in the center.

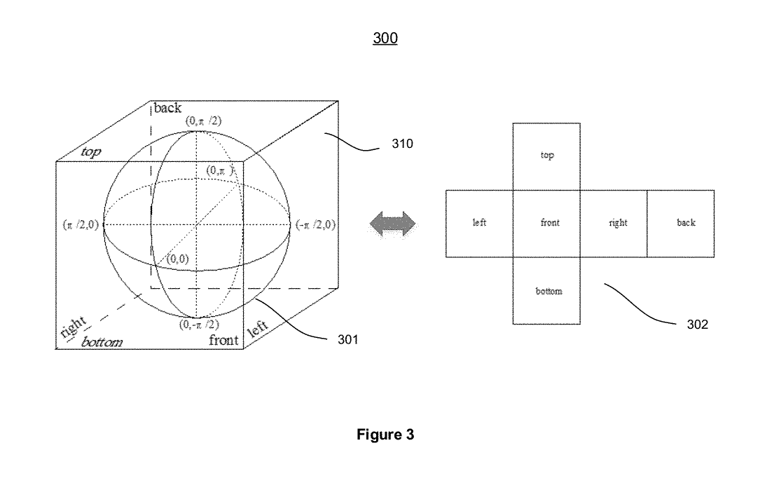

FIG. 3 illustrates an exemplary cubic face projection that maps a three dimensional spherical view to a two-dimensional layout, in accordance with various embodiments of the present disclosure. As shown in FIG. 3, using a cubic face projection, a sphere view 301 can be mapped to a two-dimensional layout 302. On the other hand, the two-dimensional layout 302 can be mapped back to the sphere view 301 in a reverse fashion.

In accordance with various embodiments, the cubic face projection for the spherical surface 301 can be based on a cube 310, e.g. a circumscribed cube of the sphere 301. In order for ascertaining the mapping relationship, ray casting can be performed from the center of the sphere to obtain a number of pairs of intersection points on the spherical surface and on the cubic faces respectively.

As shown in FIG. 3, an image frame for storing and transmitting a spherical view can include six cubic faces of the cube 310, e.g. a top cubic face, a bottom cubic face, a left cubic face, a right cubic face, a front cubic face, and a back cubic face. These six cubic faces may be expanded on (or projected to) a 2D plane.

It should be noted that the projection of a curved view such as a spherical view or an ellipsoidal view based on cubic face projection is provided for the purposes of illustration, and not intended to limit the scope of the present disclosure. For persons having ordinary skills in the art, various modifications and variations can be conducted under the teachings of the present disclosure Exemplary embodiments of projection formats for the projection pertaining to the present disclosure may include octahedron, dodecahedron, icosahedron, or any polyhedron. For example, the projections on eight faces may be generated for an approximation based on an octahedron, and the projections on those eight faces can be expanded and/or projected onto a 2D plane. In another example, the projections on twelve faces may be generated for an approximation based on a dodecahedron, and the projections on those twelve faces can be expanded and/or projected onto a 2D plane. In yet another example, the projections on twenty faces may be generated for an approximation based on an icosahedron, and the projections on those twenty faces can be expanded and/or projected onto a 2D plane. In yet another example, the projections of an ellipsoidal view on various faces of a polyhedron may be generated for an approximation of the ellipsoidal view, and the projections on those twenty faces can be expanded and/or projected onto a 2D plane.

It still should be noted that for the cubic face layout illustrated in FIG. 3, the different cubic faces can be depicted using its relative position, such as a top cubic face, a bottom cubic face, a left cubic face, a right cubic face, a front cubic face, and a back cubic face. Such depiction is provided for the purposes of illustration only, and not intended to limit the scope of the present disclosure. For persons having ordinary skills in the art, various modifications and variations can be conducted under the teachings of the present disclosure.

In accordance with various embodiments, depending on the orientation or relative position of each cubic face, the continuous relationship among various cubic faces can be represented using different continuity relationships.

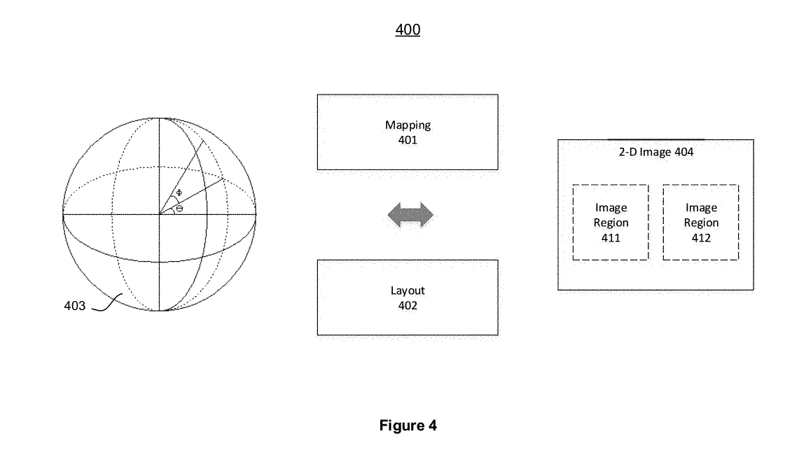

FIG. 4 illustrates mapping a curved view into a two-dimensional (2D) image, in accordance with various embodiments of the present disclosure. As shown in FIG. 4, a mapping 401 can be used for corresponding a curved view 403 to a 2D image 404. The 2D image 404 can comprise a set of image regions 411-412, each of which contains a portion of the curved view 403 projected on a face of a polyhedron (e.g. a cube).

In accordance with various embodiments, the set of image regions can be obtained by projecting said at least one portion of the curved view to a plurality of faces on a polyhedron. For example, a spherical view 403 can be projected from a spherical surface, or a portion of a spherical surface, to a set of cubic faces. In a similar fashion, a curved view can be projected from an ellipsoid surface, or a portion of an ellipsoid surface, to a set of rectangular cubic surfaces.

Furthermore, a curved view, e.g. a spherical view 403, can be mapped into a two-dimensional rectangular image 404 based on different layouts. As shown in FIG. 4, the set of image regions 411-412 can be arranged in the 2-D image 404 based on a layout 402, which defines the relative positional information, such as location and orientation, of the image regions 411-412 in the 2-D image.

As shown in FIG. 4, the spherical view 403 is continuous on every direction. In accordance with various embodiments, a set of image regions 411-412 can be obtained by projecting at least a portion of the curved view 403 to a plurality of faces on a polyhedron. The continuous relationship can be represented using a continuity relationship, which is pertinent to a particular mapping 401 and layout 402. Due to the geometry limitation, the two-dimensional image 404 may not be able to fully preserve the continuity in the spherical view 403.

In accordance with various embodiments, the system can employ a padding scheme for providing or preserving the continuity among the set of image regions 411-412 in order to improve the efficiency in encoding/decoding a spherical view video.

In accordance with various embodiments, various mapping mechanisms can be used for mapping a curved view, e.g. a spherical view 403, into a two-dimensional planar view (i.e., a curved view video can be mapped to a two-dimensional planar video). The spherical video or the partial spherical video can be captured by a plurality of cameras or a wide view camera such as a fisheye camera. The two-dimensional planar video can be obtained by a spherical mapping and can also be obtained via partial spherical mapping. The mapping method may be applied to provide a representation of a 360-degree panoramic video, a 180-degree panoramic video, or a video with a wide field of view (FOV). Furthermore, the two-dimensional planar video obtained by the mapping method can be encoded and compressed by using various video codec standards, such as HEVC/H.265, H.264/AVC, AVS1-P2, AVS2-P2, VP8 and VP9.

In accordance with various embodiments, a panoramic or wide view video, such as a 360-degree panoramic video or video with a larger field of view (FOV) may contain a large amount of data. Also, such video may need to be encoded with a high coding quality and may need to be presented with a high resolution. Thus, even after mapping and compression (e.g. using various video codec methods), the size of the compressed data may still be large. As a result, the transmission of the panoramic or wide view video remains a challenging task at the current network transmission conditions.

In accordance with various embodiments, various approaches can be used for encoding and compressing the panoramic or wide view video. For example, an approach based on viewport can be used, in order to reduce the consumption of network bandwidth, while ensuring the user to view the panoramic or wide view video with satisfactory subjective feelings. Here, the panoramic or wide view video may cover a view wider than a human sight, and a viewport can represent the main perspective in the human sight, where more attention is desirable. On the other hand, the area outside the viewport, which may only be observable via peripheral vision or not observable by a human, may require less attention.

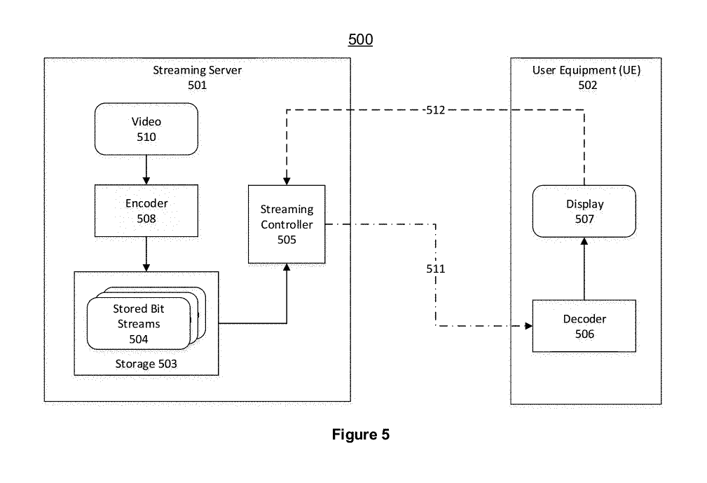

FIG. 5 illustrates an exemplary video streaming environment, in accordance with various embodiments of the present disclosure. As shown in FIG. 5, a video 501, e.g. a panoramic or wide view video with a large field of view (FOV), which may include a sequence of image frames (or pictures), can be streamed from a streaming server 501 to a user equipment (UE) 502 in a video streaming environment 500.

At the server side, an encoder 508 can encode the sequence of image frames in the video 520 and incorporate the encoded data into various bit streams 504 that are stored in a storage 503.

In accordance with various embodiments, a streaming controller 505 can be responsible for controlling the streaming of the video 510 to the user equipment (UE) 502. In some instances, the streaming controller 505 can be an encoder or a component of an encoder. In some instances, the streaming controller 505 may include an encoder or function together with an encoder. For example, the streaming controller 505 can receive user information 512, such as viewport information, from the user equipment (UE) 502. Then, the streaming controller 505 can generate a corresponding bit stream 511 based on the stored bit streams 504 in the storage 503, and transmit the generated bit stream 511 to the user equipment (UE) 502.

At the user equipment (UE) side, a decoder 506 can obtain the bit stream 511 that contains the binary data for the sequence of image frames in the video 510. Then, the decoder 506 can decode the binary data accordingly, before providing the decoded information to a display 506 for viewing by a user. On the other hand, the user equipment (UE) 502, or a component of the user equipment (UE) 502 (e.g. the display 506), can obtain updated user information, such as updated view port information (e.g. when the user's sight moves around), and provide such updated user information back to the streaming server 501. Accordingly, the streaming controller 505 may reconfigure the bit stream 511 for transmission to the user equipment (UE) 502.

In accordance with various embodiments, different types of partition schemes can be used for partitioning each of the image frames in the video 510 into a plurality of sections. For example, the partition scheme can be based on tiles or slices, or any other geometry divisions that are beneficial in video encoding and decoding. In various instances, each of the image frames in the video 510 can be partitioned into a same number of sections. Also, each corresponding section in the different image frames can be positioned at the same or substantial similar relative location and with or substantial similar same geometry size (i.e. each of the image frames in the video 510 can be partitioned in a same or substantial similar fashion).

In accordance with various embodiments, each of the plurality of sections partitioning an image frame can be configured with multiple levels of qualities. For example, at the server side, each of the plurality of sections partitioning an image frame can be configured with multiple levels of encoding qualities. At the user equipment (UE) side, each of the plurality of sections partitioning an image frame can be configured with multiple levels of decoding qualities.

In accordance with various embodiments, the encoding quality for each section in an image frame in the video 510 can be determined based on user preference, such as region of interest (ROI) information. Alternatively or additionally, the encoding quality for each section in the image frames can be determined based on viewport information for the first image frame, which can indicate a location of a viewport for the image frame. Here, a section in the image frame corresponding to the viewport can be configured to have a higher level of encoding quality than the encoding quality for another section in the image frame, which is outside of the viewport.

As shown in FIG. 5, at the server side, a plurality of bit streams 504 for the sequence of image frames in the video 510 can be stored in the storage 503. In some instances, each of the stored bit stream may contain encoded data, with a particular encoding quality, for a particular section in the sequence of image frames.

In accordance with various embodiments, the encoder 508 can take advantage of an encoding process as shown in FIG. 1. For example, the encoder 508 can prepare for encoding a sequence of image frames in the video 510 using different encoding qualities, by sharing various encoding steps such as the prediction and transformation steps. At the quantization step, the encoder 508 can apply different quantization parameters on the sequence of image frames while sharing prediction and transformation results. Thus, the encoder 508 can obtain multiple bit streams for the sequence of image frames with different encoding qualities.

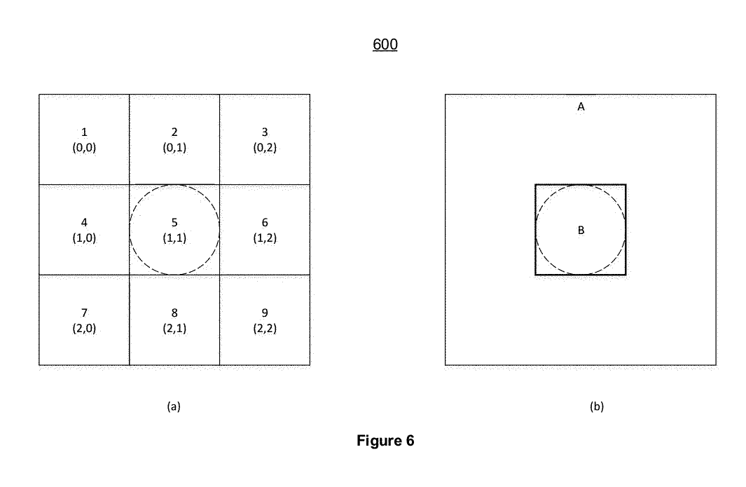

FIG. 6 illustrates exemplary image partition schemes 600 based on tiles, in accordance with various embodiments of the present disclosure. As shown in FIG. 6, a number of tiles can be used for partitioning an image frame (or picture) in a video.

In accordance with various embodiments, a tile, which is a rectangular region in an image frame, can be used for coding. For example, in various video codec standards, an image frame can be partitioned, horizontally and vertically, into tiles. In some video coding standards, such as HEVC/H.265, the height of the tiles in a same row may be required to be uniform, and the width of the tile in an image frame may not be required to be uniform. Data in different tiles in the same image frame cannot be cross-referenced and predicted (although filtering operations may be performed crossing the boundaries of different tiles in the same image). The filtering operations can include deblocking, sample adaptive offset (SAO), adaptive loop filter (ALF), and etc.

In the example as shown in FIG. 6(a), an image can be partitioned into nine sections (or regions). Each section can be encoded with different qualities. In various instances, the coding quality can be defined either quantitatively or qualitatively. For example, the coding quality may be defined as one of “High”, “Medium” or “Low” (each of which may be associated with a quantitative measure). Alternatively or additionally, the coding quality can be represented by numbers, characters, alphanumeric strings, or any other suitable representations. In various instances, the coding quality may refer to various coding objective measures, subjective measures, and different sampling ratios (or resolutions).

As shown in part (a) of FIG. 6, tile 5, i.e. area (1, 1), is covered by the viewport. Thus, the tile 5 may be assigned with a “High” quality. Furthermore, the tiles 2, 4, 6, and 8, i.e. the areas (0, 1), (1, 0), (2, 1) and (1, 2), are adjacent to the area (1, 1) corresponding to the viewport. Thus, these areas can be encoded with a “Medium” quality, since these areas are in the sight of human eye (i.e. within peripheral vision) even though they are not the focus. Additionally, tiles 1, 3, 7, and 9, i.e. the areas (0,0), (0,2), (2,0), and (2,2), are farther away from the viewport and may not be observable by the human eye. Thus, these areas may be encoded with a “Low” quality.

Alternatively, in the example shown in part (b) of FIG. 6, an image can be partitioned into two sections or areas. Each section can be encoded with different qualities, and the coding quality may be defined as one of “High”, “Medium” or “Low”. As shown in part (b) of FIG. 6, section B (e.g. a tile) is covered by the viewport. Thus, the section B may be assigned with a “High” quality. Furthermore, section A, which surrounds the section B, may be assigned with a “Low” or “Medium” quality.

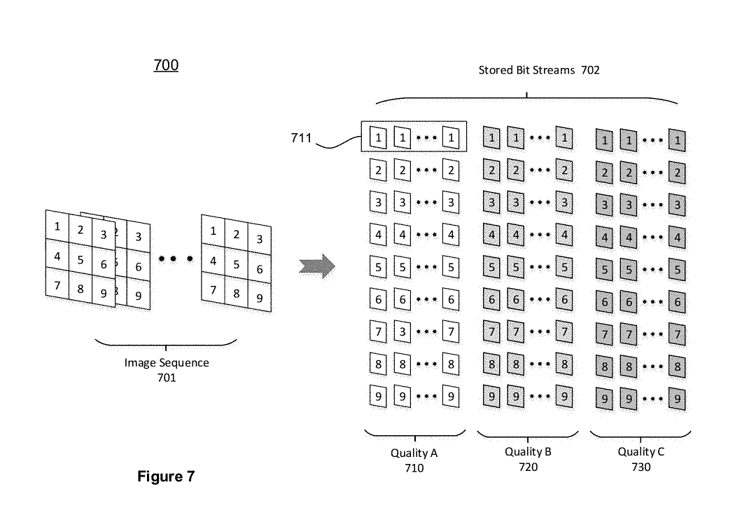

FIG. 7 illustrates encoding an image frame sequence for supporting video streaming, in accordance with various embodiments of the present disclosure. As shown in FIG. 7, an image sequence 701 can be encoded and stored as bit streams 702 in the sever 700. Here, each bit stream can be provided with a particular quality for a single section on the server side. For example, a stored bit stream 711 corresponds to encoded data with quality A (e.g. “High”) for section 1 in the image sequence.

As shown in FIG. 7, an image frame in the image sequence 701 (i.e. the video) can be partitioned into nine sections, while each section may be encoded with three qualities (e.g. A for “High”, B for “Medium” or C for “Low”). For example, the encoding can be based on various video codec standards, such as H.264/AVC, H.265/HEVC, AVS1-P2, AVS1-P2 etc.

In accordance with various embodiments, each bit stream is capable of being independent decoded. For example, each bit stream may contain independent video parameter set (VPS) information, independent sequence header information, independent sequence parameter set (SPS) information, independent picture header information, or a separate Picture Parameter Set (PPS) parameter.

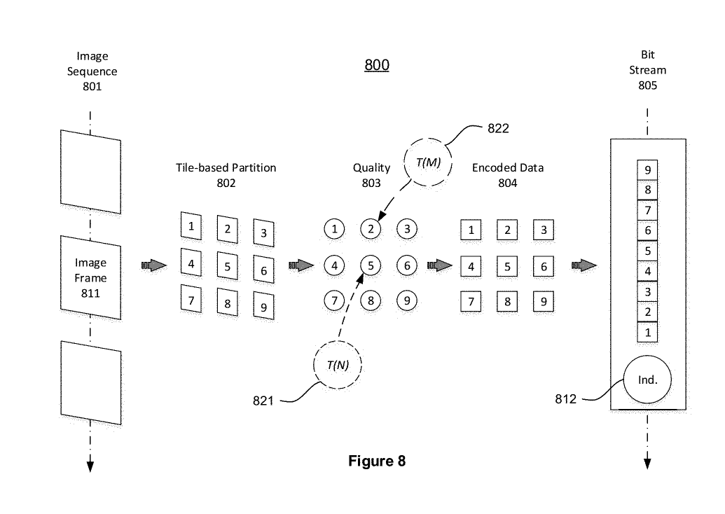

FIG. 8 illustrates supporting bit stream switching in video streaming using tiles, in accordance with various embodiments of the present disclosure. As shown in FIG. 8, using a tile-based partition scheme 802, an image frame 811 in a sequence of image frames 801 can be partitioned into a plurality of tiles (e.g. tiles 1-9). Furthermore, a streaming controller can determine encoding quality 803 for each tile in the image frame 811. Additionally, the streaming controller can obtain, from the stored bit streams in the server, encoded data 804 with the determined encoding quality for each tile of the image frame 811. Then, the streaming controller can incorporate (e.g. encapsulate) the encoded data 804 for the plurality of sections (e.g. tiles) of the first image frame in a bit stream 805 for transmission, according to a predetermined order. In some instances, the predetermined order can be configured based on relative locations of each particular section (e.g. tile) in the sequence of image frames.

In accordance with various embodiments, the streaming controller can dynamically select the encoded data, from a stored bit stream, for each section (e.g. tile) in an image frame that needs to be transmitted, according to the viewport of the user equipment (UE).

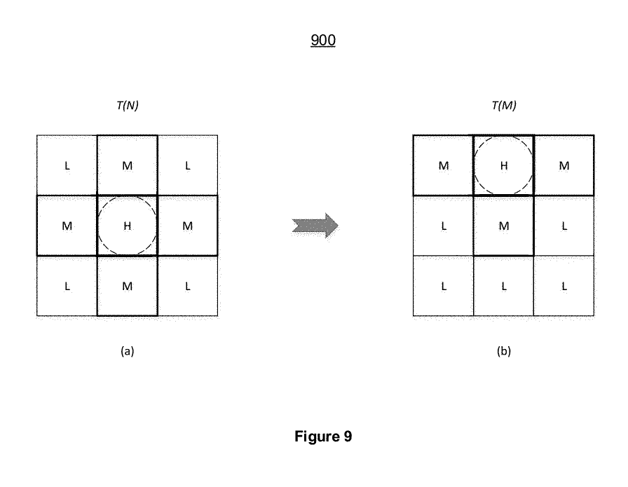

Referring to part (a) of FIG. 9, tile 5 corresponds to the viewport 821 at the time point, T(N). Thus, tile 5 may be assigned with a “High” quality (H). Furthermore, each of the titles 2, 4, 6, and 8 can be assigned with a “Medium” quality (M), and each of the tiles 1, 3, 7, and 9 can be assigned with a “Low” quality (L).

After determining the encoding quality corresponding to each of the tiles in the image frame 811, the streaming controller can obtain the encoded data with a desired quality for each tile in the image frame 811 from a corresponding stored bit stream in the server. For example, in the example as shown in part (a) of FIG. 9, the streaming controller can obtain encoded data for tile 5 from a high quality bit stream (e.g. 710 of FIG. 7). Also, the streaming controller can obtain encoded data for tiles 2, 4, 6, and 8 from medium quality bit streams (e.g. 720 of FIG. 7), and the streaming controller can obtain encoded data for tiles 1, 3, 7, and 9 from low quality bit streams (e.g. 730 of FIG. 7).

Then, the streaming controller can encapsulate the obtained encoded data for different tiles into a bit stream 805 for transmission. In various instances, the encoded data for each tile can be encapsulated according to a predetermined order. For example, the predetermined order can be configured based on a raster scanning order, which refers to the order from left to right and top to bottom in the image frame.

In accordance with various embodiments, the video streaming approach based on viewport can effectively reduce the data transmitted for the panoramic or wide view video, while taking into account the subjective experience in viewing. On the other hand, when the viewport changes, i.e. when the human sight moves around, the image section corresponding to the viewport may also change.

In accordance with various embodiments, the streaming controller can dynamically switch among different qualities of bit stream for each partitioned section that are used for generating the bit stream 805 for transmission in video streaming. For example, the streaming controller may receive viewport information at later time point for a second image frame. Here, the viewport information for the second image frame may indicate a location of a viewport for the second image frame. The second image frame follows or trails the first image frame in the sequence of image frames, and the location of the viewport for the first image frame may be different from the location of the viewport for the second image frame.

Referring to part (b) of FIG. 9, at the time point, T(M), the viewport 822 may shift to the tile 2. The streaming controller can adjust the coding quality for each tile in the image frame. As shown in part (b) of FIG. 9, tile 2 is assigned with a “High” quality (H). Furthermore, the titles 1, 3, and 5 can be assigned with a “Medium” quality (M), and the tiles 4, 6, 7, 8, and 9 can be assigned with a “Low” quality (L).

Thus, the streaming controller can perform bit stream switching at or after the time point, T(M). After determining the encoding quality for each of the tiles in the image frame, the streaming controller can obtain the encoded data with a desired quality for each tile in the image frame from the corresponding stored bit streams in the server. In the example as shown in part (b) of FIG. 9, the streaming controller can obtain encoded data for tile 2 from a high quality bit stream (e.g. 710 of FIG. 7). Additionally, the streaming controller can obtain encoded data for tiles 1, 3, and 5 from medium quality bit streams (e.g. 720 of FIG. 7), and the streaming controller can obtain encoded data for tiles 4, 6, 7, 8, and 9 from low quality bit streams (e.g. 730 of FIG. 7).

In various instances, the bit stream switching can be performed at the random access point. For example, the random access point may be an instantaneous decoding refresh (IDR) picture, a clean random access (CRA) picture, a sequence header, a sequence header +1 frame, etc.

As shown in part (b) of FIG. 9, after a change in the position of the viewport at a time point, T(M), the streaming controller may perform bit stream switching at the first random access point after the time point, T(M). For example, the streaming controller can determine encoding quality for each section in the second image frame based on the received viewport information for the second image frame, if the second image frame is at a random access point to decode the encoded data in the bit stream. Otherwise, the streaming controller can determine encoding quality for each section in the second image frame based on the encoding quality for a corresponding section in the first image frame, if the second image frame is not at a random access point to decode the encoded data in the bit stream. In such a case, the streaming controller can wait and perform bit stream switching until the first random access point after the time point, T(M).

In accordance with various embodiments, using the above scheme, the streaming controller can incorporate encoded data, with different qualities, for different sections in the image frames into a single bit stream 805. Unlike the approach relying on transmitting multiple bit streams, the above scheme can avoid the multi-channel synchronization problem. Thus, the system layer for transmitting the video code stream does not need to perform the synchronization operation, for example, using the system protocols of DASH (Dynamic Adaptive Streaming Over Http), HLS (Http Live Streaming), MPEG TS (Transport Stream). Additionally, the above scheme can avoid the need for combining data from multiple channels at the user equipment, since the location of encoded data for each tile is encapsulated accordingly to the relative location of each tile in the image frame.

Additionally, an indicator 812 can be provided and associated with the bit stream. In accordance with various embodiments, the indicator 812 can indicate that encoding prediction dependency for the particular section of each image frame in the sequence of image frames is constrained within said particular section.

In various embodiment, the indicator 812 provided by a decoder or the streaming controller at the server side can be the same or related to the indicator received by the decoder, i.e., the indicator can indicate both encoding and decoding prediction dependency.

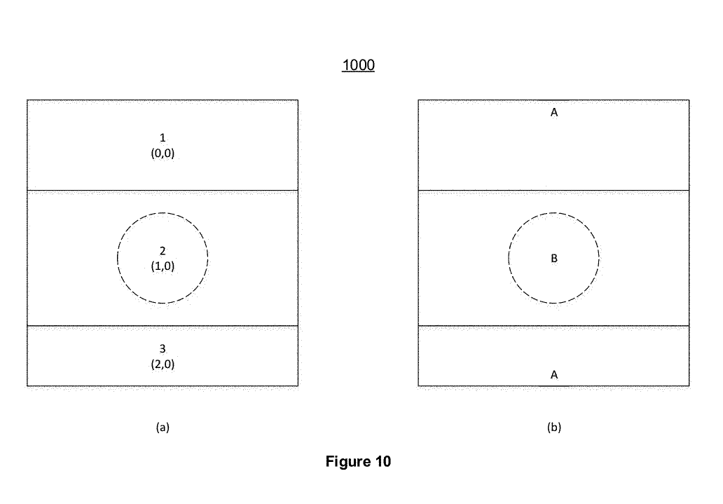

FIG. 10 illustrates exemplary image partition schemes based on slice, in accordance with various embodiments of the present disclosure. As shown in FIG. 10, a number of slices can be used for partitioning an image frame (or picture) in a video.

In accordance with various embodiments, a slice can be a sequence of slice segments starting with an independent slice segment and containing zero or more subsequent dependent slice segments that precede a next independent slice segment, in each image frame. Alternatively, a slice can be a sequence of coding blocks or a sequence of coding block pairs.

In various instances, slices can be used for video coding. For example, an image frame allows only one slice in the horizontal direction (i.e. the partition cannot be performed in the vertical direction). Data in different slices in the same image frame cannot be cross-referenced and predicted (although filtering operations may be performed crossing the boundaries of different tiles in the same image). The filtering operations include deblocking, sample adaptive offset (SAO), Adaptive Loop Filter (ALF) etc.

In the example shown in part (a) of FIG. 10, an image can be partitioned into three slices (or regions). Each slice can be encoded with different qualities. In various instances, the coding quality can be defined either quantitatively or qualitatively. For example, the coding quality may be defined as one of “High”, “Medium” or “Low” (each of which may be associated with a quantitative measure). Alternatively or additionally, the coding quality can be represented by numbers, characters, alphanumeric strings, or any other suitable representations. In various instances, the coding quality may refer to various coding objective measures, subjective measures, and different sampling ratios (or resolutions).

As shown in part (a) of FIG. 10, slice 2, i.e. area (1, 0), is covered by the viewport. Thus, the slice 2 may be assigned with a “High” quality. Furthermore, the slices 2 and 3, i.e. the areas (0, 0), and (2, 0), are adjacent to the area (1, 0) corresponding to the viewport. Thus, these areas can be encoded with a “Medium” quality.

Alternatively, in the example shown in part (b) of FIG. 10, an image can be partitioned into two sections or areas. Each section is encoded with different qualities, and the coding quality may be defined as one of “High”, “Medium” or “Low”. As shown in part (b) of FIG. 10, section B (e.g. a slice) is covered by the viewport. Thus, the section B may be assigned with a “High” quality. Furthermore, section A, which surrounds the section B, may be assigned with a “Low” or “Medium” quality.

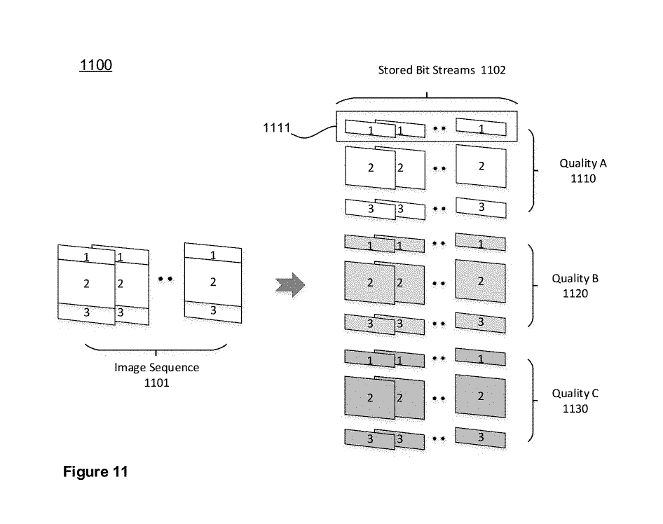

FIG. 11 illustrates encoding an image frame sequence for supporting video streaming, in accordance with various embodiments of the present disclosure. As shown in FIG. 11, an image sequence 1101 can be encoded and stored as bit streams 1102 in the sever 1100. Here, each bit stream can be provided with a particular quality for a single section on the server side. For example, a stored bit stream 1111 corresponds to encoded data with quality A (e.g. “High”) for section 1 in the image sequence 1101.

As shown in FIG. 11, an image frame in the image sequence 1101 (i.e. the video) can be partitioned into 3 sections, while each section may be encoded with three qualities (e.g. “High”, “Medium” or “Low”). For example, the encoding can be based on various video codec standards, such as H.264/AVC, H.265/HEVC, AVS1-P2, AVS1-P2 and so on.

In accordance with various embodiments, each bit stream is capable of being independent decoded. For example, each bit stream may contain independent video parameter set (VPS) information, independent sequence header information, independent sequence parameter set (SPS) information, independent picture header information, or a separate Picture Parameter Set (PPS) parameter.

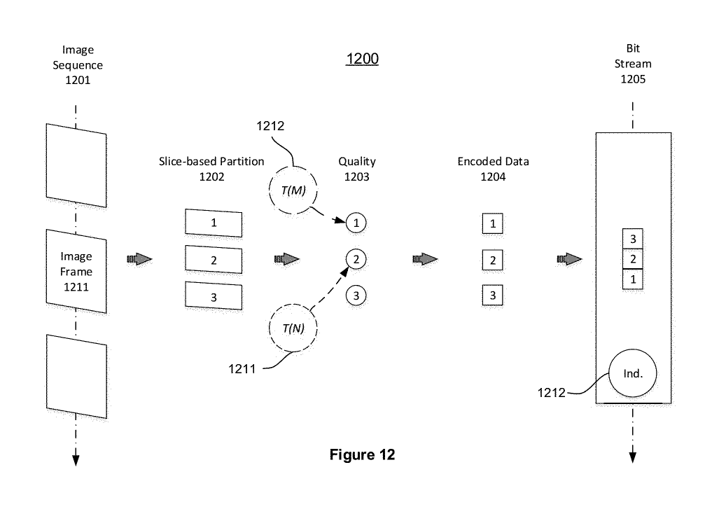

FIG. 12 illustrates supporting bit stream switching in video streaming using slices, in accordance with various embodiments of the present disclosure. As shown in FIG. 12, using a slice-based partition scheme 1202, an image frame 1211 in a sequence of image frames 1201 can be partitioned into a plurality of slices (e.g. slices 1-3). Furthermore, a streaming controller can determine encoding quality 1203 for each slice in the image frame 1211. Additionally, the streaming controller can obtain, from the stored bit streams in the server, encoded data 1204 with the determined encoding quality for each tile of the image frame 1211. Then, the streaming controller can incorporate (e.g. encapsulate) the encoded data 1204 for the plurality of sections of the first image frame in a bit stream 1205 for transmission, according to a predetermined order. In some instances, the predetermined order can be configured based on relative locations of each particular section (e.g. slice) in the sequence of image frames.

In accordance with various embodiments, the streaming controller can dynamically select the encoded data, from a stored bit stream, for each section in an image frame that needs to be transmitted, according to the viewport of the user equipment (UE).

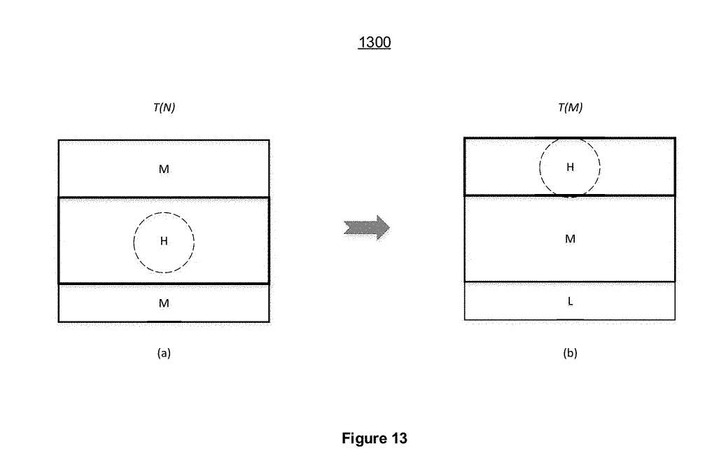

Referring to part (a) of FIG. 13, slice 2, i.e. slice (1, 0), corresponds to the viewport 1211 at the time point, T(N). Thus, the slice 2 may be assigned with a “High” quality (H). Furthermore, each of the slices 1, and 3 can be assigned with a “Medium” quality (M).

After determining the encoding quality corresponding to each of the slices in the image frame 1211, the streaming controller can obtain the encoded data with a desired quality for each slice in the image frame 1211 from a corresponding stored bit stream in the server. For example, in the example as shown in part (a) of FIG. 13, the streaming controller can obtain encoded data for slice 2 from a high quality bit stream (e.g. 1110 of FIG. 11), and the streaming controller can obtain encoded data for slice 1 and 3 from medium quality bit streams (e.g. 1120 of FIG. 11).

Then, the streaming controller can encapsulate the obtained encoded data for different slices into a bit stream 1205 for transmission. In various instances, the encoded data for each slice can be encapsulated according to a predetermined order. For example, the predetermined order can be configured based on a raster scanning order, which refers to the order from top to bottom in the image.

In accordance with various embodiments, the video streaming approach based on viewport can effectively reduce the data transmitted for the 360 degree video or a video having a large FOV, while taking into account the subjective experience in viewing. On the other hand, when the viewport changes, i.e. when the human sight moves around, the image section corresponding to the viewport may also change.

In accordance with various embodiments, the streaming controller can dynamically among different qualities of bit stream for each partitioned section that are used for generating the bit stream 1205 for transmission in video streaming. For example, the streaming controller may receive viewport information for a second image frame. Here, the viewport information for the second image frame may indicate a location of a viewport for the second image frame. The second image frame trails the first image frame in the sequence of image frames, and the location of the viewport for the first image frame is different from the location of the viewport for the second image frame.

Referring to part (b) of FIG. 13, at the time point, T(M), the viewport 1212 may shift to the slice 1, i.e. slice (0, 0). The streaming controller can adjust the coding quality for each slice in the image frame. As shown in part (b) of FIG. 13, slice 1 is assigned with a “High” quality (H). Furthermore, the slice 2 can be assigned with a “Medium” quality (M), and the slice 3 can be assigned with a “Low” quality (L).

Thus, the streaming controller can perform bit stream switching at or after the time point, T(M), when the viewport 1212 changes. After determining the encoding quality corresponding to each of the slices in the image frame, the streaming controller can obtain the encoded data with a desired quality for each slice in the image frame from a corresponding stored bit stream in the server. For example, in the example as shown in part (b) of FIG. 13, the streaming controller can obtain encoded data for slice 1 from a high quality bit stream (e.g. 1110 of FIG. 11). Additionally, the streaming controller can obtain encoded data for slice 2 from a medium quality bit stream (e.g. 1120 of FIG. 11), and the streaming controller can obtain encoded data for slice 3 from a low quality bit stream (e.g. 1130 of FIG. 11).

In various instances, the bit stream switching can be performed at the random access point. For example, the random access point may be an instantaneous decoding refresh (IDR) picture, a clean random access (CRA) picture, a sequence header, a sequence header +1 frame, etc.

As shown in part (b) of FIG. 13, after a change in the position of the viewport at a time point, T(M), the streaming controller may perform bit stream switching at the first random access point after the time point, T(M). For example, the streaming controller can determine encoding quality for each section in the second image frame based on the received viewport information for the second image frame, if the second image frame is a random access point to decode the encoded data in the bit stream. Otherwise, the streaming controller can determine encoding quality for each section in the second image frame based on the encoding quality for a corresponding section in the first image frame, if the second image frame is not a random access point to decode the encoded data in the bit stream. In such a case, the streaming controller can wait and perform bit stream switching until the first random access point after the time point, T(M).

In accordance with various embodiments, using the above scheme, the streaming controller can incorporate encoded data, with different qualities, for different sections in the image frames into a single bit stream 1205. Unlike the approach relying on transmitting multiple bit streams, the above scheme avoids the multi-channel synchronization problem. Thus, the system layer for transmitting the video code stream does not need to perform the synchronization operation, for example, using the system protocols of DASH (Dynamic Adaptive Streaming Over Http), HLS (Http Live Streaming), MPEG TS (Transport Stream). Additionally, the above scheme can avoid combining data from multiple channel at the user equipment, since the location of encoded data for each tile is encapsulated accordingly to the relative location of each tile in the image frame.

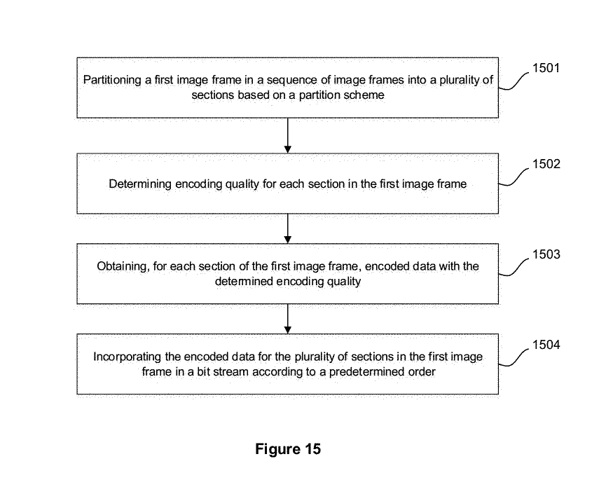

FIG. 15 illustrates a flow chart for supporting bit stream switching in video streaming, in accordance with various embodiments of the present disclosure. As shown in FIG. 15, at step 1501, the system can partition a first image frame in a sequence of image frames into a plurality of sections based on a partition scheme. At step 1502, the system can determine encoding quality for each section in the first image frame. At step 1503, the system can obtain, for each section of the first image frame, encoded data with the determined encoding quality. Furthermore, at step 1504, the system can incorporate the encoded data for the plurality of sections of the first image frame in a bit stream according to a predetermined order.

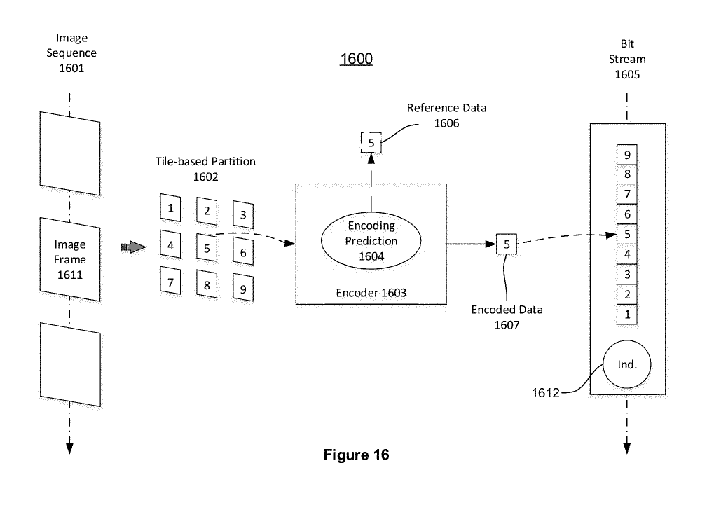

FIG. 16 illustrates encoding tiles for supporting bit stream switching in video streaming, in accordance with various embodiments of the present disclosure. As shown in FIG. 16, each image frame in a sequence of image frames can be partitioned into a plurality of sections, e.g. tiles 1-9, according to a tile-based partition scheme 1602.

In accordance with various embodiments, an encoder 1603 can perform encoding prediction 1604 for a particular section (e.g. tile 5) of an image frame 1611 in the sequence of image frames 1601. The encoding prediction 1604 can be performed based on reference data 1606 from tile 5 of a previous image frame in the sequence of image frames 1601. Then, the encoder 1603 can encode the particular section (i.e. tile 5 of the image frame 1611) based on the encoding prediction 1604, e.g. with different levels of encoding qualities. In various instances, different sections in the sequence of the image frames can be encoded independently, i.e. the encoder 1603 may not need to be aware of the encoding of other sections. For example, different tiles in the sequence of the image frames can be encoded sequentially or out-of-sync.

Furthermore, the encoded data 1607 for the particular section, tile 5, of the image frame 1611 can be incorporated in a bit stream 1605 for the sequence of image frames 1601. The encoded data with different levels of encoding qualities for the particular section, tile 5, of the image frame 1611 can be stored in a plurality of bit streams on the server before being incorporated into the bit stream 1605 for transmission. Additionally, an indicator 1612 can be provided and associated with the bit stream. In accordance with various embodiments, the indicator 1612 can indicate that encoding prediction dependency for the particular section of each image frame in the sequence of image frames is constrained within said particular section. Additionally, the indicator 1612 may indicate that only a particular section in the second image frame is used for encoding prediction. For example, the indicator 1612 can be a supplemental enhancement information (SEI) message or extension data. Also, the indicator 1612 can be a sequence parameter sets (SPS) message, a video parameter sets (VPS) message, or a sequence header.

In accordance with various embodiments, an encoder 1603 can perform encoding prediction 1604 for another section (e.g. tile 7) of an image frame 1611 in the sequence of image frames 1601. The encoding prediction 1604 can be performed based on reference data (not shown) from tile 7 of a previous image frame in the sequence of image frames 1601. Then, the encoder 1603 can encode the particular section (i.e. tile 7 of the image frame 1611) based on the encoding prediction 1604, e.g. with different levels of encoding qualities. Furthermore, the encoded data (not shown) for the particular section, tile 7, of the image frame 1611 can be incorporated in a bit stream 1605 for the sequence of image frames 1601. The encoded data with different levels of encoding qualities for the particular section, tile 7, of the image frame 1611 can be stored in a plurality of bit streams on the server before being incorporated into the bit stream 1605 for transmission.

In accordance with various embodiments, the different sections that are encoded may be obtained from different sources that are independent from each other. For example, the different tiles obtained from the different sources may not exist in a single physical image frame (i.e. the different tiles may exist in multiple separate physical image frames). Furthermore, the encoded data with different level of qualities for each tile can be stored in a plurality of bit streams on the server before being incorporated into the bit stream 1605 for transmission.

In accordance with various embodiments, data from different tiles in the same image frame cannot be used as reference data in encoding. On the other hand, without applying constraints in performing time domain encoding prediction, such as the inter-frame prediction, the tile of an image frame in the image sequence may refer to information of any region in a previous image frame.

In order to avoid the inconsistency in encoding and decoding, an encoding constraint may be applied, such that the reference data needed for motion estimation in the time domain prediction does not cross the tile boundary in each corresponding bit streams stored. As stated above, each bit stream stored on the server side corresponds to a particular quality level for an image area, i.e. a particular tile. These stored bit streams are independent from each other with no coding dependencies. Thus, in time domain prediction, the motion vector for an image block to be encoded in an image frame maybe prevented from pointing to data across the tile boundary in a previous image frame in the image sequence.

In accordance with various embodiments, the encoder can provide and associate a parameter with the bit stream for transmission. The parameter may indicate a quality associated with said particular section of the first image frame. The quality can be at least one of an encoding objective measure, an encoding subjective measure, or a resolution. For example, an encoding objective measure can be a peak signal to noise ratio (PSNR).

In accordance with various embodiments, the encoder can provide and associate a parameter set with the bit stream for transmission. The parameter set can contain a set of values, each of which indicates a quality associated with a section of the first image frame. The quality can be a sampling ratio for a section of the first image frame. Additionally, the encoder can provide and associate a parameter with the bit stream for transmission. The parameter may indicate the number of sections (e.g. tiles) in each of the images frames. Thus, the decoder can convert each different section in the first image frame in the sequence of image frames to a predetermined sampling ratio.

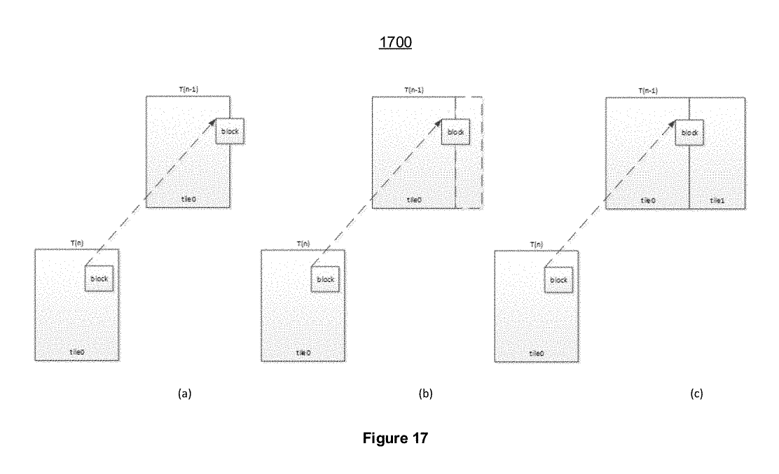

FIG. 17 illustrates tile-based encoding without inter-frame prediction dependency constraint, in accordance with various embodiments of the present disclosure. As shown in part (a) of FIG. 17, the encoding of an image block in a tile, e.g. tile 0, in an image frame at the time point, T(n), can be performed based on inter-frame prediction, which depends on a reference block in a tile (e.g. tile 0) in an image frame at the time point, T(n-1). Here, the reference block in tile 0 at the time point, T(n-1), may cross the tile boundary. As a result, at the time T(n), both the encoding motion vector and the decoding motion vector may point to reference data crossing the tile boundary.

For example, at the encoder side, as shown in part (b) of FIG. 17, each tile is coded in a separate bit stream. Thus, the reference block of tile 0 at the time point, T(n), can be obtained via extending the boundary of the tile. On other hand, at the decoder side, as shown in part (c) of FIG. 17, since multiple bit streams for different tiles are encapsulated in a single stream for transmission, multiple tiles are available for decoding inter-frame prediction. The reference block for the image block in tile 0 at the time point, T(n), may exceed the tile boundary and the reference data may include data from a neighboring tile, e.g. tile 1. Thus, the reference data for encoding and decoding can be different, which may result in inconsistency between the encoding and decoding of the tile 0 at the time point, T(n).

Thus, in order to prevent the inconsistency in the reference data obtained for encoding and decoding, a prediction constraint may be applied so that the reference data needed for motion estimation in the time domain prediction does not cross the boundary of the tile.

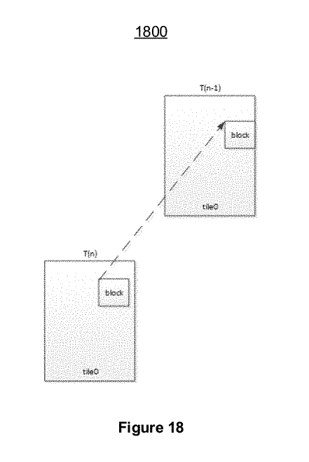

FIG. 18 illustrates tile-based encoding with inter-frame prediction dependency constraint, in accordance with various embodiments of the present disclosure. As shown in FIG. 18, an image block in tile 0 at the time point, T(n-1), is used as a reference block for an image block in tile 0 at the time point, T(n). The inter-frame prediction dependency constraint may require that the reference block of tile 0 at the point, T(n-1) does not exceed the boundary of tile 0.

In accordance with various embodiments, the inter-frame prediction dependency constraint can be applied to the reference data that are used in inter-frame prediction interpolation. For example, inter-frame prediction may involve interpolating reference data in order to estimate a value for a reference point (e.g. with a floating number coordinate). When such reference point locates close to a boundary, the inter-frame prediction dependency constraint may require that the reference data used for interpolation cannot cross the boundary of the tile (i.e. only reference data in the particular section can be used for interpolation).

Thus, it can be guaranteed that the bit stream corresponding to each tile at the server side is encoded in the same fashion as it is decoded at the user equipment (UE) side, i.e. to ensure coding consistency.

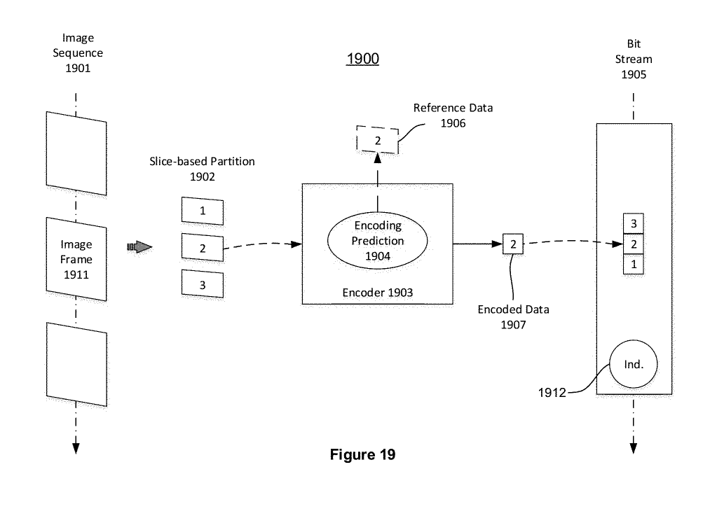

FIG. 19 illustrates encoding slices for supporting bit stream switching in video streaming, in accordance with various embodiments of the present disclosure. As shown in FIG. 19, each image frame in a sequence of image frames can be partitioned into a plurality of sections according to a slice-based partition scheme 1902.

In accordance with various embodiments, an encoder 1903 can perform encoding prediction 1904 for a particular section (e.g. slice 2) of an image frame 1911 in the sequence of image frames 1901. The encoding prediction 1904 can be performed based on reference data 1906 from slice 2 of a previous image frame in the sequence of image frames 1901. Then, the encoder 1903 can encode the particular section (i.e. slice 2 of the image frame 1911) based on the encoding prediction 1904, e.g. with different levels of encoding qualities. In various instances, different sections in the sequence of the image frames can be encoded independently, i.e. the encoder 1603 may not need to be aware of the encoding of other sections. For example, different slices in the sequence of the image frames can be encoded sequentially or out-of-sync.

Furthermore, the encoded data 1907 for the particular section, slice 2, of the image frame 1911 can be incorporated in a bit stream 1905 for the sequence of image frames 1901. Here, the encoded data with different levels of encoding qualities for the particular section, slice 2, of the image frame 1911 can be stored in a plurality of bit streams on the server before being incorporated into the bit stream 1905 for transmission. Additionally, an indicator 1912 can be associated with the bit stream 1906. In accordance with various embodiments, the indicator 1912 can indicate that encoding prediction dependency for the particular section (e.g. slice 2) of each image frame in the sequence of image frames is constrained within said particular section. Additionally, the indicator 1912 indicates that only the particular section (e.g. slice 2) in the second image frame is used for encoding prediction. For example, the indicator 1912 can be a supplemental enhancement information (SEI) message or extension data. Also, the indicator 1612 can be a sequence parameter sets (SPS) message, a video parameter sets (VPS) message, or a sequence header.

In accordance with various embodiments, an encoder 1903 can perform encoding prediction 1904 for another section (e.g. slice 3) of an image frame 1911 in the sequence of image frames 1901. The encoding prediction 1904 can be performed based on reference data (not shown) from slice 3 of a previous image frame in the sequence of image frames 1901. Then, the encoder 1903 can encode the particular section (i.e. slice 3 of the image frame 1911) based on the encoding prediction 1904, e.g. with different levels of encoding qualities. Furthermore, the encoded data (not shown) for the particular section, slice 3, of the image frame 1911 can be incorporated in a bit stream 1905 for the sequence of image frames 1901. Here, the encoded data with different levels of encoding qualities for the particular section, slice 3, of the image frame 1911 can be stored in a plurality of bit streams on the server before being incorporated into the bit stream 1905 for transmission.

In accordance with various embodiments, the different sections that are encoded may be obtained from different sources that are independent from each other. For example, the different slices obtained from the different sources may not exist in a single physical image frame (i.e. the different slices may exist in multiple separate physical image frames). Furthermore, the encoded data with different level of qualities for each slice can be stored in a plurality of bit streams on the server before being incorporated into the bit stream 1605 for transmission.

In accordance with various embodiments, without applying constraints in performing time domain encoding prediction, such as the inter-frame prediction, a slice of the current frame may refer to information of any region of in a previous image frame.

In order to avoid the inconsistency in encoding and decoding, an encoding constraint may be applied, such that the reference data needed for motion estimation in the time domain prediction does not cross the slice boundary in each corresponding bit streams stored. As stated above, each bit stream stored on the server side corresponds to a particular quality level for an image area, i.e. a particular slice. These bit streams are independent from each other with no coding dependencies. Thus, in time domain prediction, the motion vector for an image block to be encoded in an image frame maybe prevented from pointing to data across the slice boundary in a previous image frame in the image sequence.

In accordance with various embodiments, the encoder can provide and associate a parameter with the bit stream for transmission. The parameter may indicate a quality associated with said particular section of the first image frame. The quality can be at least one of an encoding objective measure, an encoding subjective measure, or a resolution. For example, an encoding objective measure can be a peak signal to noise ratio (PSNR).

In accordance with various embodiments, the decoder can provide and associate a parameter set with the bit stream for transmission. The parameter set can contain a set of values, each of which indicates a quality associated with a section of the first image frame. The quality can be a sampling ratio for a section of the first image frame. Additionally, the encoder can provide and associate a parameter with the bit stream for transmission. The parameter may indicate the number of sections (e.g. slices) in each of the images frames. Thus, the decoder can convert each different section in the first image frame in the sequence of image frames to a predetermined sampling ratio.

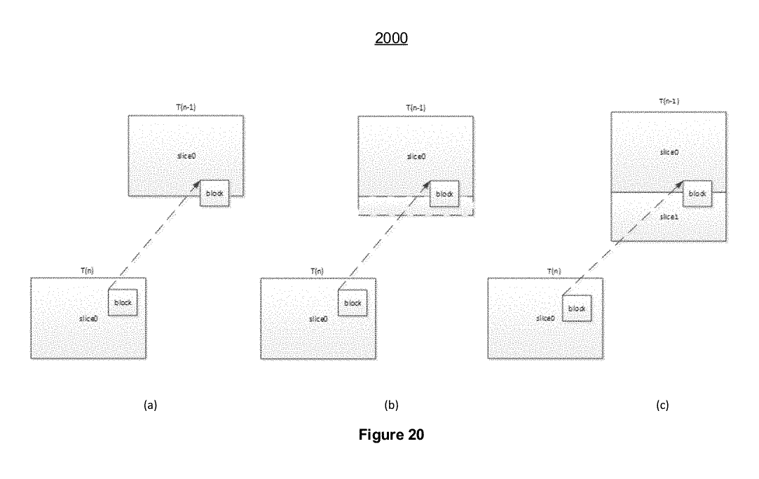

FIG. 20 illustrates slice-based encoding without inter-prediction dependency constraint, in accordance with various embodiments of the present disclosure. As shown in part (a) of FIG. 20, the encoding of an image block in a slice, e.g. slice 0, in an image frame at the time point, T(n), can be performed based on inter-frame prediction, which depends on a reference block in a slice (e.g. slice 0) in an image frame at the time point, T(n-1). Here, the reference block at the time point, T(n-1) may cross the tile boundary. As a result, at the time T(n), both the encoding motion vector and the decoding motion vector may point to reference data crossing the tile boundary.

For example, on the encoder side, as shown in part (b) of FIG. 20, each slice is coded in a separate bit stream. Thus, the reference block of slice 0 at the time point, T(n), can be obtained via extending the boundary of the slice. On the decoder side, as shown in part (c) of FIG. 20, since multiple bit streams for different slices are encapsulated in one stream for transmission, multiple slices are available for decoding inter-frame prediction. The reference block of slice 0 at the time point, T(n), may exceed the slice boundary and the reference data may include data from a neighbor slice, e.g. slice 1. Thus, the reference data for encoding and decoding can be different, which results in inconsistency between the encoding and decoding of the slice 0 at the time point, T(n).

Thus, in order to prevent the inconsistency in the reference data obtained for encoding and decoding, a prediction constraint may be applied so that the reference data needed for motion estimation in the time domain prediction does not cross the boundary of the slice.

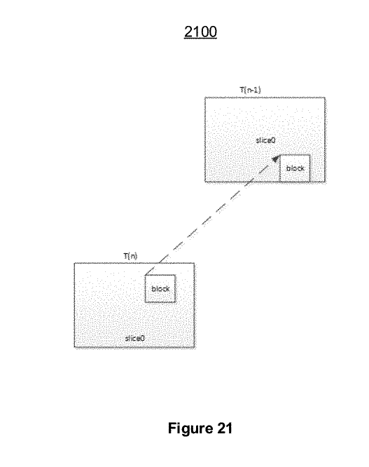

FIG. 21 illustrates slice-based encoding with inter-prediction dependency constraint, in accordance with various embodiments of the present disclosure. As shown in FIG. 21, an image block in slice 0 at the point, T(n-1), is used as a reference block for an image block in slice 0 at the point, T(n). The inter-frame prediction dependency constraint may require that the reference block of slice 0 at the point, T(n-1) does not exceed the slice boundary.

In accordance with various embodiments, the inter-frame prediction dependency constraint applies to the reference data that are used in inter-frame prediction interpolation. For example, inter-frame prediction may involve interpolating reference data in order to estimate a value for a reference point (e.g. with a floating number coordinate). When such reference point locates close to a boundary, the inter-frame prediction dependency constraint may require that the reference data used for interpolation not cross the boundary of the slice (i.e. only reference data in the particular section can be used for interpolation).

Thus, it can be guaranteed that the bit stream corresponding to each slice at the server side is encoded in the same fashion as it is decoded at the user equipment (UE) side, i.e. to ensure coding consistency.

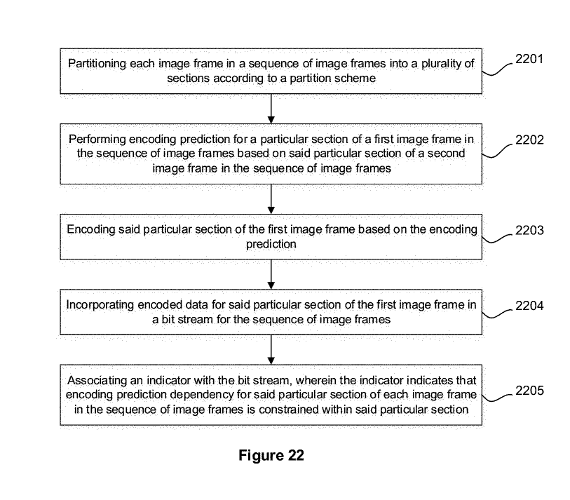

FIG. 22 illustrates a flow chart for video encoding for bit stream switching in video streaming, in accordance with various embodiments of the present disclosure. As shown in FIG. 22, at step 2201, the system can partition each image frame in a sequence of image frames into a plurality of sections according to a partition scheme. At step 2202, the system can perform encoding prediction for a particular section of a first image frame in the sequence of image frames based on said particular section of a second image frame in the sequence of image frames. At step 2203, the system can encode said particular section of the first image frame based on the encoding prediction. At step 2204, the system can incorporate encoded data for said particular section of the first image frame in a bit stream for the sequence of image frames. Furthermore, at step 2205, the system can associate an indicator with the bit stream, wherein the indicator indicates that encoding prediction dependency for said particular section of each image frame in the sequence of image frames is constrained within said particular section.

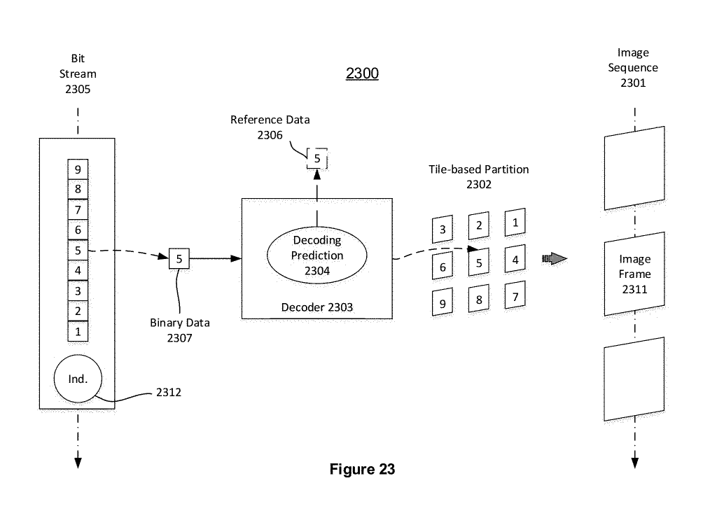

FIG. 23 illustrates decoding tiles for supporting bit stream switching in video streaming, in accordance with various embodiments of the present disclosure. As shown in FIG. 23, each image frame in a sequence of image frames can be partitioned into a plurality of sections, e.g. tiles 1-9, according to a tile-based partition scheme 2302.

In accordance with various embodiments, a decoder 2303 can perform decoding prediction 2304 for decoding a particular section (e.g. tile 5) of an image frame 2311 in the sequence of image frames 2301. The decoding prediction 2304 can be performed based on reference data 2306 from tile 5 of a previous decoded image frame in the sequence of image frames 2301. Then, the decoder 2303 can decode the particular section (i.e. tile 5 of the image frame 2311) based on the decoding prediction 2304.

Furthermore, the binary data 2307 for the particular section, tile 5, of the image frame 2311 can be obtained from a bit stream 2305 for the sequence of image frames 2301. Additionally, an indicator 2312, which is associated with the bit stream 2305, can be obtained and analyzed. In accordance with various embodiments, the indicator 2312 can indicate that decoding prediction dependency for the particular section (e.g. tile 5) of each image frame in the sequence of image frames is constrained within said particular section. Additionally, the indicator 2312 indicates that only said particular section (e.g. tile 5) in a previously decoded image frame is used for decoding prediction. For example, the indicator 2312 can be a supplemental enhancement information (SEI) message or extension data. Also, the indicator 2312 can be a sequence parameter sets (SPS) message, a video parameter sets (VPS) message, or a sequence header.

In accordance with various embodiments, data from different tiles in the same image frame can be used as reference data in decoding. On the other hand, without applying constraints in performing time domain decoding prediction, such as the inter-frame prediction, the tile of an frame may refer to information of any region of the previous frame.

In order to prevent the inconsistency in encoding and decoding, a decoding constraint may be applied, such that the reference data needed for motion estimation in the time domain prediction do not cross the tile boundary in the received bit stream. Thus, in time domain prediction, the motion vector for an image block to be decoded in an image frame maybe prevented from pointing to data across the slice boundary in a previous image frame in the image sequence.

In accordance with various embodiments, the decoder can obtain a parameter that indicates a quality associated with said particular section (e.g. tile 5) of the first image frame. The quality can be at least one of an encoding objective measure, an encoding subjective measure, or a resolution. For example, an encoding objective measure can be a peak signal to noise ratio (PSNR).

In accordance with various embodiments, the decoder can obtain a parameter set that contains a set of values, each of which indicates a quality associated with a section of the first image frame. The quality can be a sampling ratio for a section of the first image frame. Additionally, the decoder can provide and associate a parameter with the bit stream for transmission. The parameter may indicate the number of sections (e.g. tiles) in each of the images frames. Thus, the decoder can convert each different section in the first image frame in the sequence of image frames to a predetermined sampling ratio.

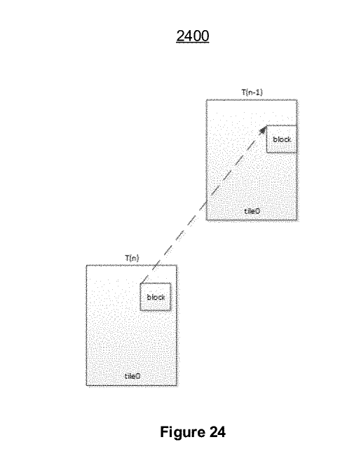

FIG. 24 illustrates tile-based decoding with inter-frame prediction dependency constraint, in accordance with various embodiments of the present disclosure. As shown in FIG. 24, an image block in tile 0 at the time point, T(n-1), can be used as a reference block for an image block in tile 0 at the time point, T(n). The inter-frame decoding prediction dependency constraint may require that the reference block of tile 0 at the point, T(n-1) does not exceed the boundary of tile 0.

In accordance with various embodiments, the inter-frame prediction dependency constraint applies to the reference data that are used in inter-frame prediction interpolation. For example, inter-frame prediction may involve interpolating reference data in order to estimate a value for a reference point (e.g. with a floating number coordinate). When such reference point locates close to a boundary, the inter-frame prediction dependency constraint may require that the reference data used for interpolation cannot cross the boundary of the tile (i.e. only reference data in the particular section can be used for interpolation). Alternatively or additionally, the encoder may apply a constraint which ensures that reference data for various prediction block do not cross the boundary of each section (e.g. tile).

Thus, it can be guaranteed that the bit stream corresponding to each tile at the server side is encoded in the same fashion as it is decoded at the user equipment (UE) side, i.e. to ensure coding consistency.

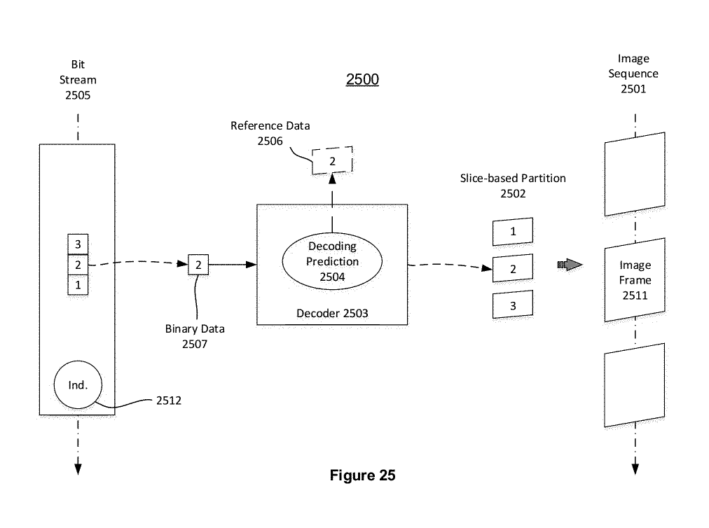

FIG. 25 illustrates decoding slices for supporting bit stream switching in video streaming, in accordance with various embodiments of the present disclosure. As shown in FIG. 25, each image frame in a sequence of image frames can be partitioned into a plurality of sections according to a partition scheme 2502

In accordance with various embodiments, a decoder 2503 can perform decoding prediction 2504 for obtaining a particular section (e.g. slice 2) of an image frame 2511 in the sequence of image frames 2501. The decoding prediction 2504 can be performed based on reference data 2506 from slice 2 of a previous image frame in the sequence of image frames 2401. Then, the decoder 2503 can decode the particular section (i.e. slice 2 of the image frame 2411) based on the decoding prediction 2504.

Furthermore, the binary data 2507 for the particular section, e.g. slice 2, of the image frame 2511 can be obtained from a bit stream 2505 for the sequence of image frames 2501. Additionally, an indicator 2512 associated with the bit stream 2506 can be obtained and analyzed. In accordance with various embodiments, the indicator 2512 can indicate that decoding prediction dependency for the particular section of each image frame in the sequence of image frames is constrained within said particular section (e.g. slice 2). Additionally, the indicator 2512 can indicate that only said particular section in the second image frame is used for encoding prediction. For example, the indicator 2512 can be a supplemental enhancement information (SEI) message or extension data. Also, the indicator 2512 can be a sequence parameter sets (SPS) message, a video parameter sets (VPS) message, or a sequence header.

In accordance with various embodiments, without applying constraints in performing time domain decoding prediction, such as the inter-frame prediction, a slice of the current frame may refer to information of any region of the previous frame. In order to prevent the inconsistency in encoding and decoding, a decoding constraint may be applied, such that the reference data needed for motion estimation in the time domain prediction do not cross the slice boundary in the received bit stream. Thus, in time domain prediction, the motion vector for an image block to be decoded in an image frame maybe prevented from pointing to data across the slice boundary in a previous image frame in the image sequence.

In accordance with various embodiments, the decoder can obtain a parameter that indicates a quality associated with said particular section of the first image frame. The quality can be at least one of an encoding objective measure, an encoding subjective measure, or a resolution. For example, an encoding objective measure can be a peak signal to noise ratio (PSNR).

In accordance with various embodiments, the decoder can obtain a parameter set that contains a set of values, each of which indicates a quality associated with a section of the first image frame. The quality can be a sampling ratio for a section of the first image frame. Additionally, the decoder can provide and associate a parameter with the bit stream for transmission. The parameter may indicate the number of sections (e.g. slices) in each of the images frames. Thus, the decoder can convert each different section in the first image frame in the sequence of image frames to a predetermined sampling ratio.

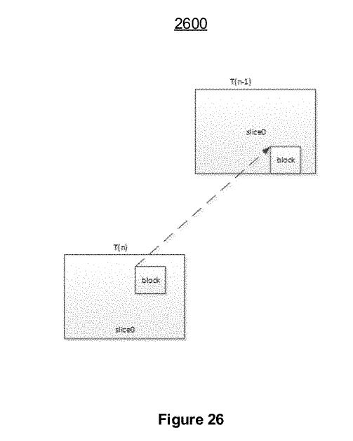

FIG. 26 illustrates slice-based decoding with inter-prediction dependency constraint, in accordance with various embodiments of the present disclosure. As shown in FIG. 26, an image block in slice 0 at the point, T(n-1), is used as a reference block for an image block in slice 0 at the point, T(n). The inter-frame decoding prediction dependency constraint may require that the reference block of slice 0 at the point, T(n-1) does not exceed the slice boundary.

In accordance with various embodiments, the inter-frame prediction dependency constraint applies to the reference data that are used in inter-frame prediction interpolation. For example, inter-frame prediction may involve interpolating reference data in order to estimate a value for a reference point (e.g. with a floating number coordinate). When such reference point locates close to a boundary, the inter-frame prediction dependency constraint may require that the reference data used for interpolation cannot cross the boundary of the slice (i.e. only reference data in the particular section can be used for interpolation). Alternatively or additionally, the encoder may apply a constraint which ensures that reference data for various prediction block do not cross the boundary of each section (e.g. slice).

Thus, it can be guaranteed that the bit stream corresponding to each slice at the server side is encoded in the same fashion as it is decoded at the user equipment (UE) side, i.e. to ensure coding consistency.

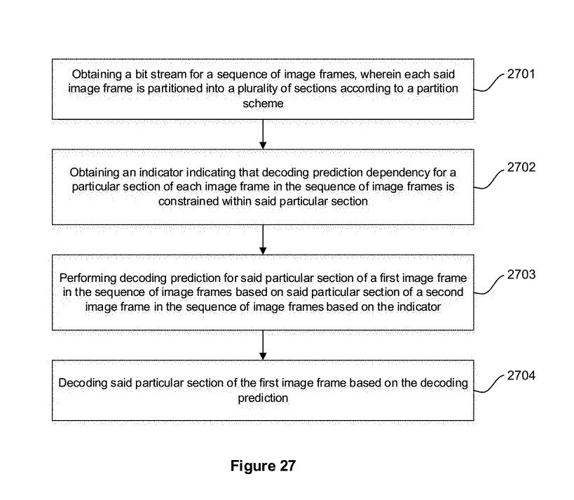

FIG. 27 illustrates a flow chart for video decoding for bit stream switching in video streaming, in accordance with various embodiments of the present disclosure. As shown in FIG. 27, at step 2701, the system can obtain a bit stream for a sequence of image frames, wherein each said image frame is partitioned into a plurality of sections according to a partition scheme. At step 2702, the system can obtain an indicator indicating that decoding prediction dependency for a particular section of each image frame in the sequence of image frames is constrained within said particular section. At step 2703, the system can perform decoding prediction for said particular section of a first image frame in the sequence of image frames based on said particular section of a second image frame in the sequence of image frames based on the indicator. Furthermore, at step 2704, the system can decode said particular section of the first image frame based on the decoding prediction.

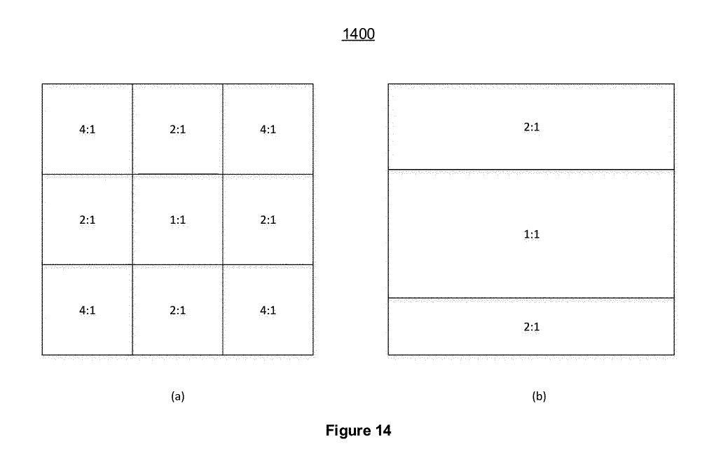

FIG. 14 illustrates supporting scaling for bit stream switching in video streaming, in accordance with various embodiments of the present disclosure.

In accordance with various embodiments, the encoding quality for each section (or region) in an image frame can define a sampling ratio (e.g. a resolution). For example, the sampling ratio can represent the ratio of the amount of data in the raw pixel data of the certain section (or region) to the amount of data being transmitted in the bit stream. For example, if the data amount for a certain region in an image is N and the sampling ratio is M:1, then the data amount of the region transmitted in the code stream is N/M. As shown in part (a) of FIG. 14, different tiles in an image frame can have different sampling ratios. As shown in part (b) of FIG. 14, different slices in an image frame can have different sampling ratios.

In various embodiments, the sampling ratio can be configured differently in the horizontal direction and vertical direction, i.e., the horizontal and vertical directions maybe sampled differently. At the encoding end (i.e. the server side), the encoder can sample the sequence of image frames in the video, and encodes the sampling ratio and provide the encoded data in the transmitted bit stream. At the decoding end (i.e. the user equipment (UE) side), the decoder can decode the binary data and perform a reverse sampling operation to adjust the decoded data for each section of the image frame to a predetermined scale, e.g. the original scale.

In accordance with various embodiment, the sampling operation and reverse sampling operation can be implemented using various image processing technique. For example, assume the sampling rate is A:B, the system performs a down-sampling operation if the value of A is larger than B. On the other hand, the system performs an up-sampling if A is less than B, and perform no sampling operation if A is equal to B.

The advantage of using different coding qualities via different sampling ratios is that the system can perform a higher degree of down-sampling operation for non-key areas in order to reduce the amount of data to be encoded, transmitted, and decoded. On the other hand, the system can perform a lower degree of down-sampling operation, or no sampling, for key areas, such as the section corresponding to the viewport, to guarantee the coding quality of the region.

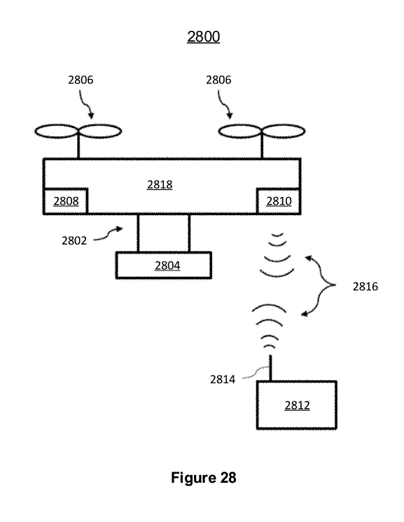

FIG. 28 illustrates a movable platform environment, in accordance with various embodiments of the present disclosure. As shown in FIG. 28, a movable platform 2818 (also referred to as a movable object) in a movable platform environment 2800 can include a carrier 2802 and a payload 2804. Although the movable platform 2818 can be depicted as an aircraft, this depiction is not intended to be limiting, and any suitable type of movable platform can be used. One of skill in the art would appreciate that any of the embodiments described herein in the context of aircraft systems can be applied to any suitable movable platform (e.g., a UAV). In some instances, the payload 2804 may be provided on the movable platform 2818 without requiring the carrier 2802. In accordance with various embodiments of the present disclosure, various embodiments or features can be implemented in or be beneficial to the operating of the movable platform 2818 (e.g., a UAV).

In some embodiments, the movable platform 2818 may include one or more movement mechanisms 2806 (e.g. propulsion mechanisms), a sensing system 2808, and a communication system 2810. The movement mechanisms 2806 can include one or more of rotors, propellers, blades, engines, motors, wheels, axles, magnets, nozzles, or any mechanism that can be used by animals, or human beings for effectuating movement. For example, the movable platform may have one or more propulsion mechanisms. The movement mechanisms 2806 may all be of the same type. Alternatively, the movement mechanisms 2806 can be different types of movement mechanisms. The movement mechanisms 2806 can be mounted on the movable platform 2818 (or vice-versa), using any suitable means such as a support element (e.g., a drive shaft). The movement mechanisms 2806 can be mounted on any suitable portion of the movable platform 2818, such on the top, bottom, front, back, sides, or suitable combinations thereof.

In some embodiments, the movement mechanisms 2806 can enable the movable platform 2818 to take off vertically from a surface or land vertically on a surface without requiring any horizontal movement of the movable platform 2818 (e.g., without traveling down a runway). Optionally, the movement mechanisms 2806 can be operable to permit the movable platform 2818 to hover in the air at a specified position and/or orientation. One or more of the movement mechanisms 2806 may be controlled independently of the other movement mechanisms. Alternatively, the movement mechanisms 2806 can be configured to be controlled simultaneously. For example, the movable platform 2818 can have multiple horizontally oriented rotors that can provide lift and/or thrust to the movable platform. The multiple horizontally oriented rotors can be actuated to provide vertical takeoff, vertical landing, and hovering capabilities to the movable platform 2818. In some embodiments, one or more of the horizontally oriented rotors may spin in a clockwise direction, while one or more of the horizontally rotors may spin in a counterclockwise direction. For example, the number of clockwise rotors may be equal to the number of counterclockwise rotors. The rotation rate of each of the horizontally oriented rotors can be varied independently in order to control the lift and/or thrust produced by each rotor, and thereby adjust the spatial disposition, velocity, and/or acceleration of the movable platform 2818 (e.g., with respect to up to three degrees of translation and up to three degrees of rotation).

The sensing system 2808 can include one or more sensors that may sense the spatial disposition, velocity, and/or acceleration of the movable platform 2818 (e.g., with respect to various degrees of translation and various degrees of rotation). The one or more sensors can include any of the sensors, including GPS sensors, motion sensors, inertial sensors, proximity sensors, or image sensors. The sensing data provided by the sensing system 2808 can be used to control the spatial disposition, velocity, and/or orientation of the movable platform 2818 (e.g., using a suitable processing unit and/or control module). Alternatively, the sensing system 108 can be used to provide data regarding the environment surrounding the movable platform, such as weather conditions, proximity to potential obstacles, location of geographical features, location of manmade structures, and the like.

The communication system 2810 enables communication with terminal 2812 having a communication system 2814 via wireless signals 2816. The communication systems 2810, 2814 may include any number of transmitters, receivers, and/or transceivers suitable for wireless communication. The communication may be one-way communication, such that data can be transmitted in only one direction. For example, one-way communication may involve only the movable platform 2818 transmitting data to the terminal 2812, or vice-versa. The data may be transmitted from one or more transmitters of the communication system 2810 to one or more receivers of the communication system 2812, or vice-versa. Alternatively, the communication may be two-way communication, such that data can be transmitted in both directions between the movable platform 2818 and the terminal 2812. The two-way communication can involve transmitting data from one or more transmitters of the communication system 2810 to one or more receivers of the communication system 2814, and vice-versa.

In some embodiments, the terminal 2812 can provide control data to one or more of the movable platform 2818, carrier 2802, and payload 2804 and receive information from one or more of the movable platform 2818, carrier 2802, and payload 2804 (e.g., position and/or motion information of the movable platform, carrier or payload; data sensed by the payload such as image data captured by a payload camera; and data generated from image data captured by the payload camera). In some instances, control data from the terminal may include instructions for relative positions, movements, actuations, or controls of the movable platform, carrier, and/or payload. For example, the control data may result in a modification of the location and/or orientation of the movable platform (e.g., via control of the movement mechanisms 2806), or a movement of the payload with respect to the movable platform (e.g., via control of the carrier 2802). The control data from the terminal may result in control of the payload, such as control of the operation of a camera or other image capturing device (e.g., taking still or moving pictures, zooming in or out, turning on or off, switching imaging modes, change image resolution, changing focus, changing depth of field, changing exposure time, changing viewing angle or field of view).

In some instances, the communications from the movable platform, carrier and/or payload may include information from one or more sensors (e.g., of the sensing system 2808 or of the payload 2804) and/or data generated based on the sensing information. The communications may include sensed information from one or more different types of sensors (e.g., GPS sensors, motion sensors, inertial sensor, proximity sensors, or image sensors). Such information may pertain to the position (e.g., location, orientation), movement, or acceleration of the movable platform, carrier, and/or payload. Such information from a payload may include data captured by the payload or a sensed state of the payload. The control data transmitted by the terminal 2812 can be configured to control a state of one or more of the movable platform 2818, carrier 2802, or payload 104. Alternatively or in combination, the carrier 2802 and payload 2804 can also each include a communication module configured to communicate with terminal 2812, such that the terminal can communicate with and control each of the movable platform 2818, carrier 2802, and payload 2804 independently.

In some embodiments, the movable platform 2818 can be configured to communicate with another remote device in addition to the terminal 2812, or instead of the terminal 2812. The terminal 2812 may also be configured to communicate with another remote device as well as the movable platform 2818. For example, the movable platform 2818 and/or terminal 2812 may communicate with another movable platform, or a carrier or payload of another movable platform. When desired, the remote device may be a second terminal or other computing device (e.g., computer, laptop, tablet, smartphone, or other mobile device). The remote device can be configured to transmit data to the movable platform 2818, receive data from the movable platform 2818, transmit data to the terminal 2812, and/or receive data from the terminal 2812. Optionally, the remote device can be connected to the Internet or other telecommunications network, such that data received from the movable platform 2818 and/or terminal 2812 can be uploaded to a website or server.

Many features of the present disclosure can be performed in, using, or with the assistance of hardware, software, firmware, or combinations thereof. Consequently, features of the present disclosure may be implemented using a processing system (e.g., including one or more processors). Exemplary processors can include, without limitation, one or more general purpose microprocessors (for example, single or multi-core processors), application-specific integrated circuits, application-specific instruction-set processors, graphics processing units, physics processing units, digital signal processing units, coprocessors, network processing units, audio processing units, encryption processing units, and the like.

Features of the present disclosure can be implemented in, using, or with the assistance of a computer program product which is a storage medium (media) or computer readable medium (media) having instructions stored thereon/in which can be used to program a processing system to perform any of the features presented herein. The storage medium can include, but is not limited to, any type of disk including floppy disks, optical discs, DVD, CD-ROMs, microdrive, and magneto-optical disks, ROMs, RAMs, EPROMs, EEPROMs, DRAMs, VRAMs, flash memory devices, magnetic or optical cards, nanosystems (including molecular memory ICs), or any type of media or device suitable for storing instructions and/or data.

Stored on any one of the machine readable medium (media), features of the present disclosure can be incorporated in software and/or firmware for controlling the hardware of a processing system, and for enabling a processing system to interact with other mechanism utilizing the results of the present disclosure. Such software or firmware may include, but is not limited to, application code, device drivers, operating systems and execution environments/containers.

Features of the disclosure may also be implemented in hardware using, for example, hardware components such as application specific integrated circuits (ASICs) and field-programmable gate array (FPGA) devices. Implementation of the hardware state machine so as to perform the functions described herein will be apparent to persons skilled in the relevant art.

Additionally, the present disclosure may be conveniently implemented using one or more conventional general purpose or specialized digital computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

While various embodiments of the present disclosure have been described above, it should be understood that they have been presented by way of example, and not limitation. It will be apparent to persons skilled in the relevant art that various changes in form and detail can be made therein without departing from the spirit and scope of the disclosure.

The present disclosure has been described above with the aid of functional building blocks illustrating the performance of specified functions and relationships thereof. The boundaries of these functional building blocks have often been arbitrarily defined herein for the convenience of the description. Alternate boundaries can be defined so long as the specified functions and relationships thereof are appropriately performed. Any such alternate boundaries are thus within the scope and spirit of the disclosure.

The foregoing description of the present disclosure has been provided for the purposes of illustration and description. It is not intended to be exhaustive or to limit the disclosure to the precise forms disclosed. The breadth and scope of the present disclosure should not be limited by any of the above-described exemplary embodiments. Many modifications and variations will be apparent to the practitioner skilled in the art. The modifications and variations include any relevant combination of the disclosed features. The embodiments were chosen and described in order to best explain the principles of the disclosure and its practical application, thereby enabling others skilled in the art to understand the disclosure for various embodiments and with various modifications that are suited to the particular use contemplated. It is intended that the scope of the invention be defined by the following claims and their equivalence.

What is claimed is:

1. A method for video decoding, comprising:
obtaining a bit stream for a sequence of image frames, wherein each said image frame is partitioned into a plurality of sections according to a partition scheme;
obtaining an indicator indicating that decoding prediction dependency for a particular section of each image frame in the sequence of image frames is constrained within said particular section;
upon obtaining the indicator, performing decoding prediction for said particular section of a first image frame in the sequence of image frames based on said particular section of a second image frame in the sequence of image frames; and
decoding said particular section of the first image frame based on the decoding prediction.

2. The method of claim 1, wherein said indicator indicates that said particular section is a tile, which is a rectangular region, in each image frame.

3. The method of claim 1, wherein said indicator indicates that said particular section is a slice, which is:
a sequence of one or more slice segments starting with an independent slice segment and containing zero or more subsequent dependent slice segments that precede a next independent slice segment, in each image frame, or
a sequence of coding blocks or a sequence of coding block pairs.

4. The method of claim 1, wherein said indicator indicates that only said particular section in the second image frame is used for decoding prediction.

5. The method of claim 1, wherein said indicator is a supplemental enhancement information (SEI) message or extension data.

6. The method of claim 1, wherein said indicator is a sequence parameter sets (SPS) message, a video parameter sets (VPS) message, or a sequence header.

7. The method of claim 1, further comprising
obtaining a parameter that indicates a quality associated with said particular section of the first image frame.

8. The method of claim 7, wherein said quality indicates at least one of an encoding objective measure, an encoding subjective measure, or a sampling ratio.

9. The method of claim 8, wherein said encoding objective measure is a peak signal to noise ratio (PSNR).

10. The method of claim 1, further comprising
obtaining a parameter that indicates the number of sections in the first image frame; and
obtaining a parameter set that contains a set of values, each of which indicates a quality associated with each of the plurality of sections of the first image frame.

11. The method of claim 10, wherein the quality indicates a sampling ratio for each of the plurality of sections of the first image frame.

12. The method of claim 11, further comprising
converting each different section in the first image frame in the sequence of image frames to a predetermined sampling ratio associated with each section.

13. The method of claim 1, wherein said indicator indicates that decoding prediction dependency for each section of each image frame in the sequence of image frames is constrained within each particular section.

14. The method of claim 13, wherein each image frame in the sequence of image frames is partitioned with the same partition scheme, and the plurality of sections in each image frame are at same relative locations.

15. The method of claim 1, wherein the decoding prediction comprises inter-frame prediction.

16. The method of claim 15, wherein the inter-frame prediction is performed for said particular section of the first image frame in the sequence of image frames based on said particular section in the second image frame in the sequence of image frames, and wherein a relative location of said particular section in the first image frame is same as or substantially similar to a relative location of said particular section in the second image frame.

17. The method of claim 16, wherein reference data used in the inter-frame prediction for said particular section of the first image frame in the sequence of image frames is constrained within said particular section of the second image frame for the sequence of image frames.

18. The method of claim 1, wherein the reference data comprise data used in inter-frame prediction interpolation.

19. A system for video decoding, comprising:
one or more microprocessors with a decoder running on the one or more microprocessors, wherein the decoder operates to:
obtain a bit stream for a sequence of image frames, wherein each said image frame is partitioned into a plurality of sections according to a partition scheme;
obtain an indicator indicating that decoding prediction dependency for a particular section of each image frame in the sequence of image frames is constrained within said particular section;
upon obtaining the indicator, perform decoding prediction for said particular section of a first image frame in the sequence of image frames based on said particular section of a second image frame in the sequence of image frames; and
decode said particular section of the first image frame based on the decoding prediction.

20. An apparatus, comprising
a processor; and
a non-transitory computer-readable medium with instructions stored thereon, wherein the instructions, when executed by the processor, cause the processor to:
obtain a bit stream for a sequence of image frames, wherein each said image frame is partitioned into a plurality of sections according to a partition scheme;
obtain an indicator indicating that decoding prediction dependency for a particular section of each image frame in the sequence of image frames is constrained within said particular section;
upon obtaining the indicator, perform decoding prediction for said particular section of a first image frame in the sequence of image frames based on said particular section of a second image frame in the sequence of image frames; and
decode said particular section of the first image frame based on the decoding prediction.
